(19) United States
(12) Patent Application Publication
(10) Pub. No.: US 2013/0157571 A1
(43) Pub. Date: Jun. 20, 2013

(54) System for wireless remote monitoring of alarm events of a medical device and corresponding patient

(71) Applicants: Anthony David Wondka, Thousand Oaks, CA (US); Dene Iliff, Riverside, CA (US)

(72) Inventors: Anthony David Wondka, Thousand Oaks, CA (US); Dene Iliff, Riverside, CA (US)

(73) Assignees: Dene Robert Iliff, Riverside, CA (US); ANTHONY DAVID WONDKA, THOUSAND OAKS, CA (US)

(21) Appl. No.: 13/506,903

(22) Filed: May 22, 2012

Related U.S. Application Data
(60) Provisional application No. 61/577,194, filed on Dec. 19, 2011.

(51) Int. Cl. H04B 7/26; H04B 17/00

(52) U.S. Cl. 455/41.2

(57) ABSTRACT

A wireless remote alarm system is described to allow a mobile caregiver or clinician to track the alarm status of a life-critical medical device and patient while the caregiver or clinician is located away from the patient. The system includes automatic recognition of the medical device's alarm output circuit for universal compatibility, in order to render the system practical, convenient and reliable to deploy, and protocols for signal reliability, security and power management. The system also includes alarm differentiation protocols to assist the caregiver with alarm prioritization, and remote patient management applications via wider-area network connectivity. The system is especially useful in alternate care and homecare settings, and for monitoring patients using a ventilator.

### PRIORITY CLAIM

This application claims priority to U.S. Provisional Patent Applications 61/488,723 filed on May 21, 2011 and 61/577,194 filed on Dec. 19, 2011.

### FIELD OF THE INVENTION

The present invention relates to the field of life critical medical equipment, and more specifically to wireless remote monitoring of alarm conditions related to patients being treated with life critical equipment.

### BACKGROUND OF THE INVENTION

Various forms of critical and life-supporting medical equipment are commonplace in the hospital setting and home care setting. Some examples of critical equipment include: life-critical respiratory support in which a patient is dependent on a respiratory ventilator, oxygen therapy devices, heart assist devices, kidney treatment devices, infusion devices, and in the case of neonatal care, incubators. For brevity purposes throughout the descriptions herein, respiratory ventilators are used as an example. These equipment typically include alarms to alert the caregiver when an equipment malfunction occurs, or when the patient's condition deteriorates, changes or is unsafe. The equipment also often includes a remote alarm to alert a clinician at a central station. These alarms work using a wired connection between the equipment and the central monitoring station to transfer the alarm information to the remote monitor. In the hospital setting, clinicians monitor the alarm conditions. In the homecare setting, a family member is typically the designated full time caregiver. While the remote wired alarm transfer devices help alert a caregiver to a problem when the caregiver is not in the immediate vicinity of the patient, they have significant limitations.

Because of today's evolving heath care environment, an urgent need has arisen for an improved method of remotely monitoring these patients and equipment. Some of the dynamics that have made this need more acute than in the past, specifically, (1) increased pressure on health care economics driving critical patients out of the hospital setting and into alternate settings including the home, (2) the aging population causing a higher number of people being treated with life-critical problems, (3) improved technologies making it possible to treat critically ill patients that previously could not be treated, and (4) clinicians being forced to care for more patients than before, due to cost controls. One such opportunity for improving remote monitoring is with a local-area wireless remote monitor, that the caregiver can have on his or her person, and that connects with a wide-area-network for improved patient management.

To date, there has been no wireless remote alarm transfer systems commercialized for ventilation equipment, although some have been described in the literature. Those described have various drawbacks as will be described later, and because of those drawbacks they will simply not suffice in many clinical situations. It is the aim of the present invention to provide a wireless remote alarm monitor that can be reliably and conveniently used in all clinical situations, and which solves many of the logistic and technical problems that the prior art does not adequately address. Further, it is the aim of the present invention to connect the remote alarm monitor to a wider-area-network for enhanced patient management based on the alarm events.

A literature and search review of the prior art indicates predominantly hard-wired remote alarms, and one reference to wireless remote alarms for ventilators. The conventional technology used in remote alarm monitoring of ventilators and other medical equipment is transmission of a signal through a wire to a remote alarm box, or to a central monitor. An alarm active condition is transmitted to a visual and or audible indicator on the remote box or central monitor. Typically, the hard wired remote alarm is provided by the equipment manufacturer to assure compatibility with the medical device, in order to avoid reliability problems and failures associated with compatibility problems. Some examples of remote ventilator alarms include Hoffrichter Gmbh's model Alarmbox, ResMed's models BOI010525 and BOI015128, Respironics' models 1003741, 1003742 and 1003743. These systems are not cross-compatible with ventilators across brands, and are not cross-compatible with different models of same brand ventilators, necessitating multiple models. Because of their non-compatibility across models, the manufacturers must carry different model alarm units for different model ventilators. This is a significant logistical and cost disadvantage. For example, in the homecare setting, there is typically a back-up ventilator which is usually a different model then the primary ventilator, and often ventilators are switched out with newer models. When switching out ventilators, the remote alarm unit will have to be also switched out, therefore increasing costs. To date, there have been no universally compatible remote alarm systems described to solve this problem. These remote alarm systems are also limited in their utility because they are hard wired systems. Some recent non-hard-wired wireless remote alarm monitors for medical equipment, such as for ventilators, have also been described in the prior art. For example, the Pacific-Medico APM-100 and APM-Plus remote ventilator monitor, is a commercially available system that is configured to be universally compatible with a variety of ventilators. Rather than interfacing with the ventilator's alarm system, this device interfaces with the patient to create a secondary alarm system that is separate for the ventilator's alarm system. Therefore this system bypasses any potential compatibility issues related to interfacing with the ventilators existing alarm system. The secondary alarm system is created by tee-ing into the ventilation gas delivery circuit and airway of the patient with a pressure transducer. The pressure transducer monitors the system for an absence in pressure which indicates a gas delivery circuit disconnect, or a hard failure of the ventilator. It can also theoretically monitor for an over-pressure condition. However, this system has significant drawbacks and limitations including (1) the system requires attachment to the gas delivery circuit and therefore introduces an additional potential failure point in the system, (2) the device's required monitoring sophistication adds unnecessary cost that many home users will not be able to afford, and (3) an array of other potential life critical events can also occur with the ventilator and patient, that will not be detected by this system, making it unwise to rely on for a remote wireless alarm monitor. Such events include for example a low or high breath rate, or low minute volume, low exhaled tidal volume, a circuit leak, breath stacking or inadvertent PEEP. So, while this device solves the universal compatibility problem, it creates other safety problems.

U.S. Patent Application 2010/0078017 (Andrieux) describes a wireless remote monitoring system for ventilators, including monitoring of alarms. The key element Andrieux describes is the use of signal repeaters to extend the transmission and reception range of the monitoring system. However, this system does not solve the cross-compatibility problems described earlier, and therefore does not solve the unmet need that exists today since it cannot be reliably deployed into the marketplace.

U.S. Patent Application 2007/0227537 (Bemister) describes a protocol for treating a patient, including wireless communication of the operation of a medical device used in the treatment to remote peripheral devices where the information can be accessed. Implicit in this invention is the ability to wirelessly communicate alarm conditions of a ventilator to a remote monitor. However, the system is completely not cross-compatible with different brands and models of medical devices. The Bemister invention offers a different solution than the present invention—that of remotely managing the treatment protocol of a patient, which is not the intent of the present invention. Bemister invention still leaves a significant unmet need—that of reliably deploying with universal compatibility a wireless remote alarm, and therefore Bemister is not a practical solution for monitoring alarms in the homecare or certain institutional care environments.

Eventually there may be a universal standard for monitoring medical equipment with PDA type devices, such as DROID™ smart phones, and this technology might be adopted as a standard wireless remote monitoring technology. However, the current infrastructure in society and the marrying of the logistics among the various suppliers that would be involved, is far off from materializing, and if it does ever occur, it is a decade away from becoming a solution. Therefore, until that time and likely well beyond, there is and will be an urgent need for an improved technique to wirelessly and remotely monitor the alarm status of a critical device and corresponding patient. As the prevalence increases of discharging patients out of expensive care settings into lower cost care settings, the need to facilitate reliable monitoring will increase. And, as clinicians are forced to assume more and more responsibility, the need to monitor the status of a patient without being in the immediate proximity of the patient, will increase.

### SUMMARY OF THE INVENTION

The present invention describes a system to remotely and wirelessly receive alarm information from a life-critical medical device. The system provides a reliable and convenient means to capture and handle the alarm information, making it a practical solution.

In a first main embodiment of the present invention a universal wireless transmitter and remote receiver is described. The universal transmitter is adapted to automatically, or semi-automatically, identify the type of alarm output circuit and or signal that is being used by the host medical device, and automatically adapt to process the signal using a protocol suitable for that output signal. The universal transmitter also includes a modular physical attachment scheme to physically connect with multiple configurations of outputs found in medical devices, as well as an electronic circuit and protocol capable of distinguishing between multiple output circuits found in medical devices.

In a second main embodiment of the present invention the wireless remote alarm monitoring system includes alarm differentiation protocols and algorithms to distinguish between and/or prioritize different alarm types.

In a third main embodiment of the present invention the wireless remote alarm monitoring system is used in a wider-area network for communication with remote persons. The wider-area network system includes algorithms and protocols to manage and optimize the efficiency of the treatment of the patient and maintenance of the medical device.

In a fourth main embodiment of the present invention the wireless remote alarm monitoring system includes a power management protocol to reduce power consumption and extend battery duration, without sacrificing fidelity of monitoring.

In a fifth main embodiment of the present invention a paired transmitter and receiver is described with signal processing protocols to prevent cross-talk between different paired systems. A communication protocol, along with the accompanying circuit and algorithm, statistically guarantees that the receiver will recognize and process only the signal transmitted from the appropriate transmitter and medical device, and not accidentally a signal from a different nearby medical device. This is useful for example in the event multiple systems are being used in proximity to one another, such as in a nursing home, alternate care facility, medical unit in a hospital, or field casualty use.

In a sixth main embodiment of the present invention, a single receiver is described which may simultaneously receive, differentiate between, process and display multiple signals that are transmitted from multiple transmitters. This is useful in situations where a caregiver is taking care of multiple patients, for example in a medical intensive care unit. This configuration allows the caregiver to carry only one receiver while monitoring multiple patients.

These embodiments and additional embodiments, such as out of range detection and alert, battery power detection and low power alert, and modular connectivity, will be described in more detail in the subsequent sections.

### BRIEF DESCRIPTION OF THE FIGURES

FIG. 1 describes an overall schematic view of the invention.

FIG. 2 describes the general sequence of operation of the invention.

FIG. 3 schematically describes the general alarm monitoring aspect of the invention.

FIG. 4 describes a schematic view of the transmitter module.

FIG. 5 describes a connector with a connection detection feature

FIG. 6 describes a schematic view of the receiver module.

FIG. 7 shows a clinician or caregiver wearing the receiver module.

FIG. 8 schematically shows the operation of the transmitter module.

FIG. 9 describes a transmitter module transmission timing protocol to prevent signal cross talk by transmitting at random transmissions times to prevent cross-talk.

FIG. 10 describes a transmitter module transmission timing protocol to prevent signal cross talk by transmitting the first transmission at a unique time to prevent cross-talk.

FIG. 11 describes a transmitter module data packet for transmission to the receiver module.

FIG. 12 describes a receiver module data packet for transmission to the transmitter module.

FIG. 13 schematically describes the operation of the receiver module.

FIG. 14 describes an overall schematic of an aspect of the invention in which multiple medical devices and patients are monitored by a common receiver module.

FIG. 15 describes a schematic view of the receiver module described in FIG. 14.

FIG. 16 schematically describes the operation of the receiver module described in FIGS. 14 and 15.

FIG. 17 schematically describes an algorithm for detecting the medical device alarm output circuit configuration, in which the system is powered on when the medical device alarms are inactive.

FIG. 18 schematically describes an algorithm for detecting the medical device alarm output circuit configuration in which the system is synchronized to the alarm output circuit by a user input.

FIG. 19 schematically describes an algorithm for determining the reception range status of the receiver module and distinguishes between borderline range conditions and out-of-range conditions.

FIG. 20 schematically describes a timing diagram of a receiver module range detection protocol which determines the range of the receiver module and distinguishes between borderline range conditions and out-of-range conditions.

FIG. 21 describes an alternative overall view of the invention with an alarm transmitting module integrated into the medical device and a central reception and signal processing station.

FIG. 22 describes an extended external network aspect of the invention to connect to and communicate with a remote person or system.

FIG. 23 describes an aspect of the invention with the system integral to a home health monitoring station for overall patient health management.

FIG. 24 describes a user interface of a transmitter module.

FIG. 25 describes an alternative user interface of a transmitter module.

FIG. 26 describes a user interface of a receiver module.

FIG. 27 describes an alternative user interface of a receiver module.

FIG. 28 describes a user interface of a multi-patient receiver module.

FIGS. 29-33 describe alarm differentiation protocols.

FIG. 29 describes an alarm differentiation and prioritization protocol based on the duration or persistence of the alarm condition.

FIG. 30 describes an alarm differentiation and prioritization protocol in which the persistence of the alarm condition determines if the alarm is high or low priority.

FIG. 31 describes an alarm differentiation protocol based on an alarm-specific output signal from the medical device.

FIG. 32 describes a version of the alarm differentiation protocol of FIG. 31 in which the alarm output contact is cycled from closed to open at a frequency specific to a specific alarm.

FIG. 33 describes an alarm differentiation protocol in which the medical device alarm output is normally open, and closed upon an alarm condition, and in which an alarm specific code is applied to the closed circuit for alarm recognition.

FIG. 34 describes a power management protocol to conserve power consumption.

FIG. 35 describes the details of the power management protocol described in FIG. 34.

FIG. 36 describes an algorithm to remotely correlate alarm events to a clinical situation and a protocol to clinically intervene as appropriate based on the clinical situation.

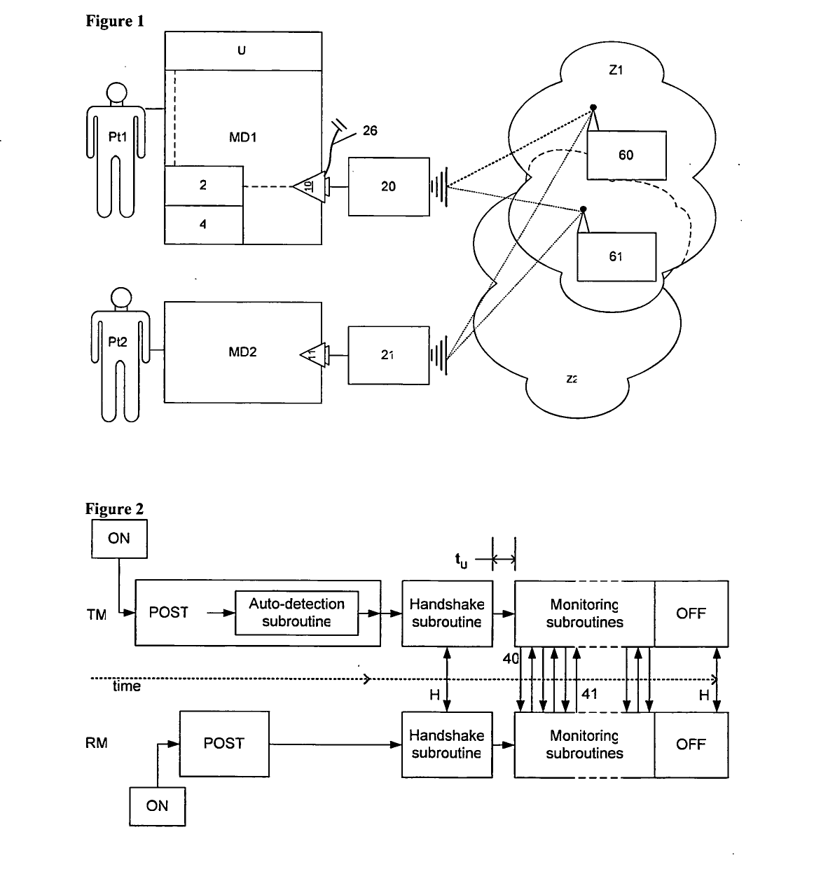

The elements in FIGS. 1-36 are defined as follows; Pt: Patient; Pt1: Patient one; Pt2: Patient two; G: Remote Guardian; D: Remote Clinician; C: Caregiver or clinician; Z: Transmission Zone; Z1: Transmission Zone 1; Z2: Transmission Zone 2; MD: Medical Device; MD1: Medical Device 1; MD 2: Medical Device 2; ao: Alarm output signal; AA: Alarm A; AB: Alarm B; AC: Alarm C; AAS: Alarm A signal frequency; AAB: Alarm B signal frequency; AAC: Alarm C signal frequency; ta: Minimum transmission time interval; tb: Maximum transmission time interval; t: Transmission interval; tu: Randomly generated unique time interval; t1: Randomly generated unique time interval 1; t2: Randomly generated unique time interval 2; t3: Randomly generated unique time interval 3; tT: Transmission time (duration); tf: Time of Initial (first) data transmission; ti: Time interval between self test completion and Initial (first) data transmission; t0: Transmitter turned ON; t0′: Medical Device Alarm Output circuit configuration determined; t0″: Power ON self test complete; ROST: Power on self test; H: Handshake between RM and TM; UI: User interface; TM: Transmission Module; RM: Receiver Module; 2: Medical device monitoring system; 4: Medical device control system; 10: Medical Device 1 alarm output connector; 11: Medical Device 2 alarm output connector; 12: Medical Device 1 monitoring system; 13: Medical Device 1 control system; 14: Medical Device 1 user interface; 15: Medical Device 2 monitoring system; 16: Medical Device 2 control system; 17: Medical Device 2 user interface; 18: Patient Call button; 19: Integrated Wireless Transmitter Module; 20: Wireless Transmitter Module 1; 21: Wireless Transmitter Module 2; 22: Ventilator alarm output connector; 23: External Power Inlet; 24: Output connector adaptor or second type of connector; 25: Charging circuit; 26: Wired remote alarm connection outlet; 27: ON/OFF, Power type selection button; 28: Transmitter pcb; 29: Alarm Status and operational status indicators; 30: Microprocessor; 31: RM find button; 32: Memory; 33: Wireless cellular or internet transceiver device; 34: TM Transceiver; 35: Speaker; 36: Battery; 37: RM range gauge; 38: TM-MD alarm status synch button (alarm active or inactive); 39: TM-Ventilator alarm status synch button; 40: Transmission signal, unit 1; 40′: Transmission signal, unit 2; 40″: Transmission signal, unit 3; 41: RM acknowledgement signal; 42: Connector cord; 44: Adaptor leash; 45: Power Cord; 46: TM bracket; 47: Cord storage bracket; 48: Cord connector; 49: Cord strain relief; 50: TM Battery gauge; 51: TM RM Range gauge; 52: High priority alarm; 53: Low priority alarm; 54: Medical device connection alarm; 55: Power type indicator; 56: TM fault indicator; 57: High priority ventilator visual alarm; 58: Low priority ventilator visual alarm; 59: RM battery gauge; 60: Receiver Module, System 1; 61: Receiver Module, System 2; 62: PCB; 63: Microphone; 64: Microprocessor; 65: Mounting Magnet; 66: Memory 67: GPS receiver; 68: RM Transceiver; 69: Accelerometer; 70: External Power Input; 71: Charging circuit; 72: Rechargeable Battery; 73: Memory battery; 74: Alarm silence and/or alarm reset and Test; 75: Patient call indicator; 76: Visual Alarm, high priority, unit 1; 76′: Visual Alarm, high priority, unit 2; 76″: Visual Alarm, high priority, unit 3; 78: Visual Alarm, low priority, unit 1; 78′: Visual Alarm, low priority, unit 2; 78″: Visual Alarm, low priority, unit 3; 79: Label area to mark as patient 1, 2 or 3; 80: Vibrator element; 81: Power ON/OFF/test button; 82: Speaker; 84: Receiver module fault alarm; 90: Multi-unit Receiver Module; 92: Memory interface; 93: Docking station; 94: Alarm Output connector; 95: Remote alarm cable; 96: Remote alarm unit (e.g., central station or remote module); 105: Medical Device mounting magnet; 106: Medical Device mounting bracket; 107: Power cord; 108: Cord/cable storage bracket; 110: Receiver Module Lanyard; 112: Receiver module master visual alert indicator; 113: Transmitter module master visual alert indicator; 114: Receiver module Ventilator alarm status indicator; 116: Receiver module Transmitter module status indicator; 118: Receiver module functional status indicator; 120: Receiver in range indicator; 122: Receiver module Power ON indicator; 124: Receiver module System Status indicator; 126: Receiver module Speaker screen; 128: Receiver module Speaker boss; 130: Receiver module ON/OFF button; 132: Receiver module Alarm silence/Alarm test button; 134: Receiver module Patient identifier indicator(s); 136: Transmitter module Power ON indicator; 138: Transmitter module system status indicator; 140: Transmitter module ventilator alarm status indicator; 142: Transmitter module functional status indicator; 144: Transmitter module speaker screen; 146: Transmitter module speaker boss; 148: Transmitter module ON/OFF button; 150: Transmitter module alarm silence/test button; 152: Ventilator alarm output circuit configuration synchronization button; 154: Arm, wrist or waist strap; 155: RM RM fault indicator; 156: RM TM fault indicator; 200: Short duration signal; 201: Medium duration signal; 202: Long duration signal; 203: MD Alarm definition subroutine; 204: Low frequency or non-cycling alarm contact state; 205: Medium frequency alarm contact state; 206: High frequency alarm contact state; 210: Home health monitoring station; 212: Home health monitoring station UI.

### DETAILED DESCRIPTION OF THE INVENTION

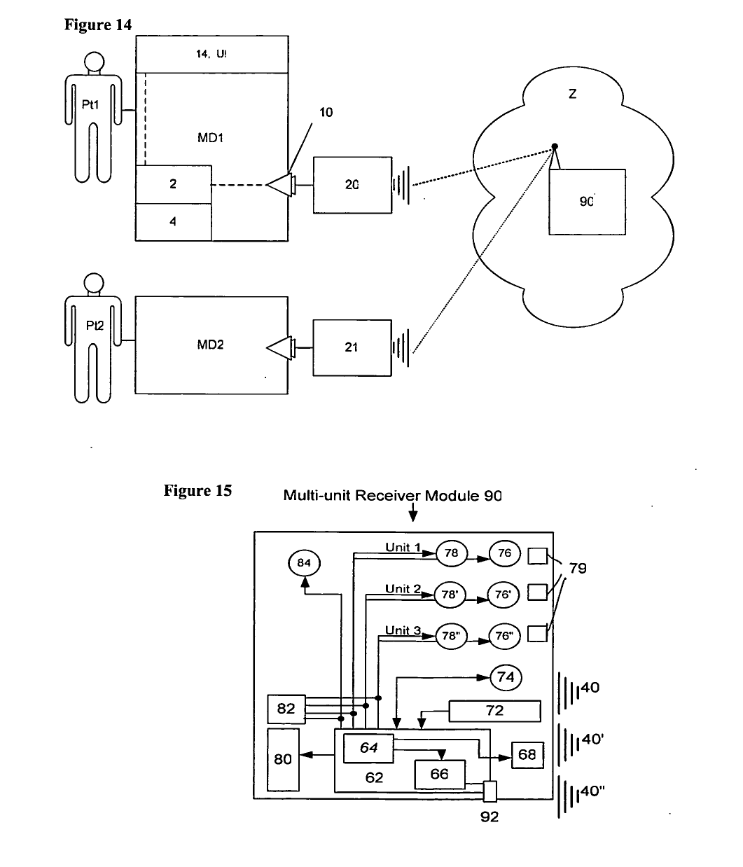

FIG. 1 describes an overall schematic of the invention. A medical device is being used to support a patient, such as a ventilator being used for respiratory support. The device typically includes a control subsystem and monitoring subsystem to control the operation of the device, and to monitor the operation of the medical device respectively. Often, the monitoring system detects problems with the patient or the medical device. The problems are typically communicated to a clinician or caregiver in the proximity of the patient and the medical device via a user interface. The user interface typically includes both audible and visual alarms, alerts, and messages. These information are typically prioritized into dire and non-dire events. Often, a critical care medical device has an alarm event output outlet connector and circuit, so that a wired remote alarm unit can be connected to the outlet, allowing the alarm status to be monitored remotely. The alarm unit is typically a box or a monitor at a central station, with a long electrical cord including a plug on the end to attach to the medical device outlet. This remote monitor allows the caregiver or clinician to monitor the medical device and the patient from the next room, or from a central station where multiple patients are being monitored. For the remote alarm, there exists multiple styles of outlets and plugs, and multiple types or electrical configurations of the alarm status output signal. In the present invention however, the conventional wired remote alarm module is replaced with a wireless system that includes a wireless transmitter and wireless remote portable receiver. However, as previously mentioned, a wireless transmitter and receiver has inherent challenges and potential problems and risks related to signal recognition integrity, accuracy, reliability and deployment. To overcome these obstacles, the system in the invention includes a universal plug compatible with multiple outlet styles, an electrical circuit universally compatible with different alarm output electrical circuit configurations, an anti-cross talk feature to prevent bombardment from wireless signals, and other features. A receiver R1, paired with a transmitter T1, will work within the transmission zone Z1 to monitor a patient and medical device P1, MD1; and to monitor a second medical device MD2 and patient Pt2, will use a second receiver and transmitter, R1 and T1. As shown in FIG. 14, a clinician or a caregiver can bare the remote wireless receiver in a number of ways, including on a waist band or belt clip, on a wrist or arm band, on a neck lanyard, or in a pocket. The clinician or caregiver can go about other activities and move around the facility or home with the remote receiver while still being able to monitor the medical device and patient. If the remote receiver R1 receives a signal from another remote receiver such as R2, the signal is received without wasting processing power and bandwidth of the receiver module R1 using special algorithms. If the remote receiver R1 moves out of the transmission zone Z1, the remote receiver will detect this out of range condition and alert the user. Other communication protocols and algorithms used to assure reliability and accuracy will be described in the subsequent sections.

FIG. 2 describes the sequence of operation of the invention when applied to a medical ventilator. The TM goes through an internal self test after power on, then performs the alarm output configuration detection to establish the proper communication with the ventilator. The detection may be automatic, semi-automatic with an input from a user, or manual with an input from a user. Once the TM configures itself to the proper alarm output circuitry, it attempts to perform a wireless handshake with the RM. If the RM has been powered ON and has completed its internal power on self test, it initiates or participates in the wireless handshake with the TM module. In the handshake, the TM and RM verify their pairing with one another, establish a statistically unique transmission time as an anti-cross-talk measure, and other functions as will be described subsequently. After the completion of the handshake routine, the monitoring function begins until terminated electively or otherwise. Various aspects of the monitoring function related to security, transmission integrity, anti-cross-talk, alarm differentiation, power management, range, and others, will be described subsequently.

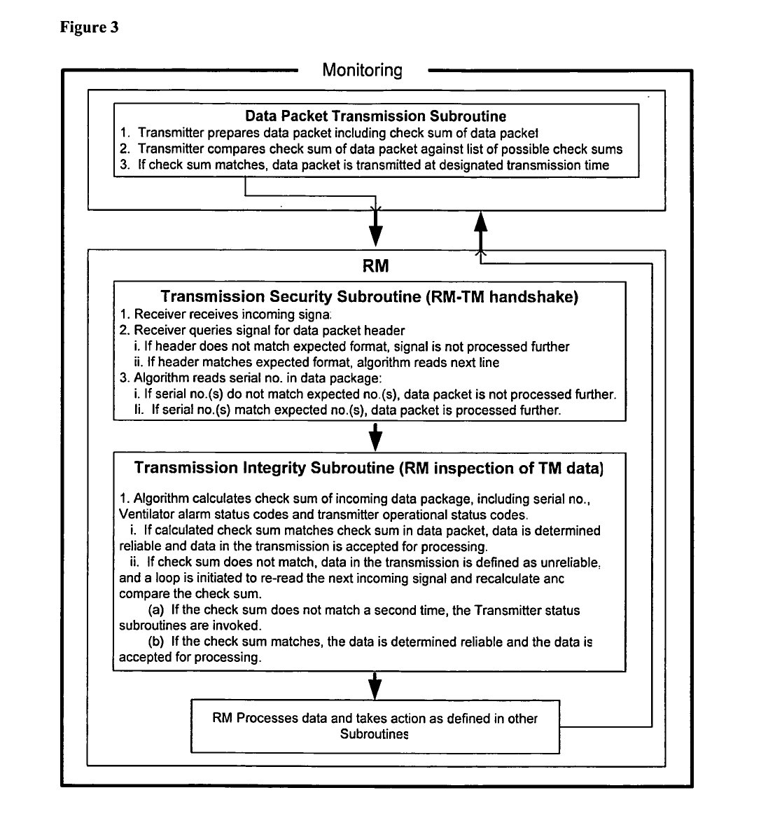

FIG. 3 describes in additional detail the flow of information during monitoring. A data packet is prepared by the TM and if verified, transmitted. The RM screens the incoming signal for correctness, and if correct, receives and processes the signal. The signal is then processed further for data integrity within the data packet. If correct, the RM notifies the TM that a valid data packet has been received.

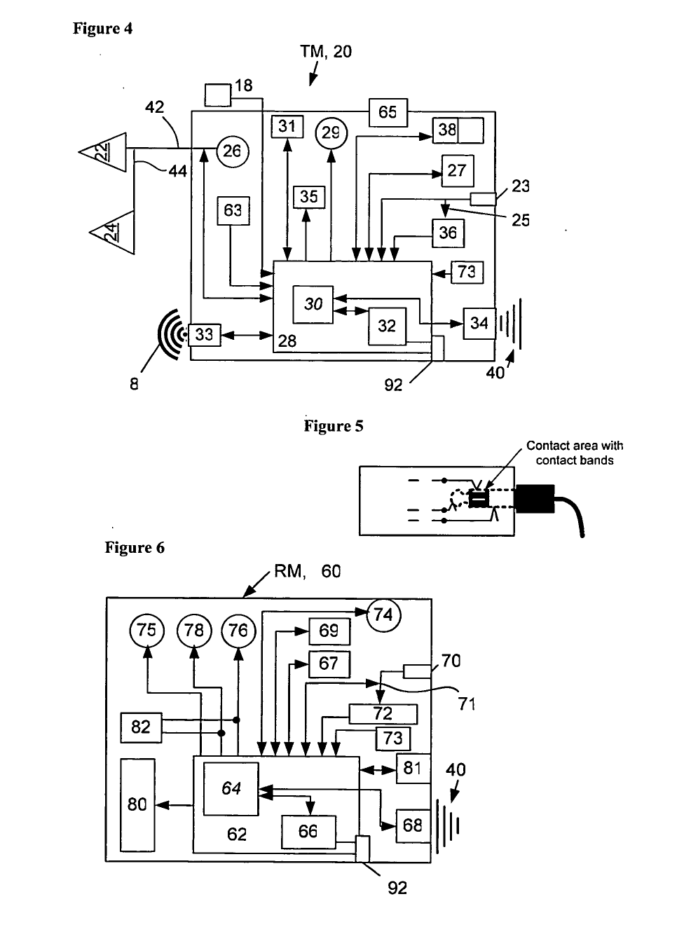

FIG. 4 describes a schematic view of the wireless transmitter module 20. The module is connected to a medical device alarm output outlet connector with a universal connector arrangement. The arrangement can include a cable 42 with multiple physical styles of plugs, or a plug 22 with one or more plug adaptors 24, so that the transmitter module can be connected to all conceivable alarm outlet jacks that are anticipated to be found on medical devices. Some examples of plug configuration options included in the universal plug/adaptor system include: 2-conductor jacks such as phono jack connectors, USB connectors, coaxial connectors, FM connectors, Ethernet connectors, phone jack connectors and mini-sub D connectors. In one embodiment shown in FIG. 5, the connector plug 22 may include a contact area with contacts bands that are isolated from one another. When inserted into a mating receptacle, the contact in the receptacle closes two neighboring contact bands on the plug to close the circuit between the contact bands, thereby indicating that the plug is inserted into the receptacle. This feature can be used to signify to the TM that the TM is connected to the medical device alarm output. Otherwise, the TM is aware that it is not connected. In addition the TM may include an outlet connector 26 so that a conventional hard wired remote alarm can still be used with the medical device. The wired remote alarm outlet can be part of the cable and connector arrangement or part of the enclosure of the transmitter module. The transmitter module may also include an alarm status input 38. The alarm status input prompts the user to identify if the medical device alarm condition is active or inactive. The input from the user, for example pressing a button, will semi-automatically define the normal alarm inactive state of the alarm output signal of the medical device for the algorithm in the wireless transmitter module. For example, if the wireless transmitter module is powered ON when an alarm is active on the medical device, the user is prompted to press an “alarm active” button if an alarm is active, the user presses the “alarm active” button, and the transmitter module defines the output signal from the medical device as alarm active. If however, the user presses the “alarm inactive” button when prompted after power ON, the transmitter module defines the output signal from the medical device at that moment as “alarm inactive”. The system may also be designed so that at any time the transmitter is powered ON, the alarm active or alarm inactive button can be pressed to synchronize the alarm status detection algorithm of the transmitter module with the medical device. If for some reason the transmitter module protocols cannot properly process the signal from the medical device, the transmitter module may include a compatibility alert message.

An internal battery 36 is included in the module. The battery can be replaceable or rechargeable or both. A second battery can be included as a redundancy. Alternatively power can be supplied from an external source, for example from the ventilator, or an AC power input and the battery is used as a secondary power source during power outages or during transport. A pcb is included with a microprocessor in communication with the transmitting element, and memory, and a memory access port. A unique identifier or serial number is associated with each transmitter module, and is typically set in the microprocessor. The transmitting element can by an RF transmitter. Memory may be for example an EEPROM. An alarm condition visual indicator is provided to indicate the alarm status of the medical device, and the operational status of the transmitter module. The alarm can be prioritized. An alarm reset and clear function can be provided, or the alarm condition can be automatically reset and cleared when the medical device alarm condition is reset and cleared. Additional details pertaining to the protocols and algorithms of creating and transmitting of information will be described subsequently. The module is typically affixed to the medical device with a simple bracket or fastener. Alternately, the module can be integrated into the enclosure of the medical device, or positioned in the immediate proximity of the medical device, for example clamped to a nearby table, bedrail or IV pole.

The TM may also include a patient call button 18 and function with which the patient can call the caregiver, a cell signal transmitter 33 to interface with a cellular or internet wifi wireless network, a RM find button and function 31, a memory battery 73, an external power inlet connector 23 and battery charge circuit 25, an alarm status synchronization switch 27 and function, a microphone to assist in synchronizing the TM to the alarm status of the medical device, a mounting magnet to mount the TM to the medical device or a nearby metal surface, and optionally a GPS device to assist in locating the medical device during transport.

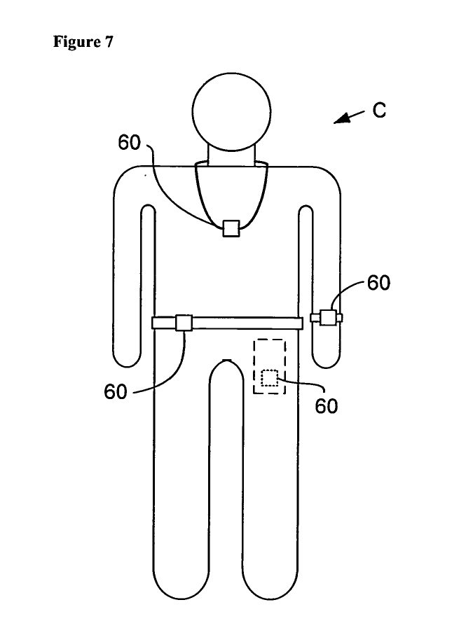

FIG. 6 describes the receiver module of the present invention. The receiver module includes a power on and test button 81, a receiving element 68 to receive the wireless signal 40 from the transmitter module, a pcb 62 with a microprocessor 64, memory 66 and memory access port 92, a power source, typically an internal battery 72, a memory battery 73 at least one visual alarm, an audible alarm 82, an alarm silence and or alarm reset and or alarm clear feature 74, typically a button, a vibration element 80 for vibrating the module during an alarm condition, a patient call indicator 75, and high and low priority alarm visual indicators 76, 78. As shown in FIG. 7, the receiver module 60 can be worn or borne by the caregiver in an unobtrusive and convenient manner as previously described, either around the neck, on the wrist or belt, or in a pocket. The receiver module will have a default status OK indicator that is always enabled if there are no alarms occurring and if the operational status of the receiver and transmitter is OK, thereby confirming that the unit is powered ON and working normally. The RM may also include an accelerometer 69 and GMS receiver 67 to monitor movement and location. The RM may include a power inlet 70 for external power and charging circuit 71 to charge the battery. The RM and TM may also include a master reset switch to override current function and restore desired default values, and a mini USB connector for both power charging and data transfer. The visual alarms may be especially large and noticeable so that an alarm condition is not easily overlooked. The module may be water tight to allow use in wet environments. Should the caregiver place or bring the module out of range of the transmitter, the receiver module will alarm. Should there be a problem with the operational status of either the transmitter module or the receiver module, the receiver module will alarm. The microprocessor includes the necessary protocols and algorithms to determine if the receiver module is within range of the transmitter, to confirm data received by the wireless receiver is being transmitted from the paired transmitter module prior to additional signal processing, to determine if there is an alarm condition active at the medical device and or transmitting module, and the operational status of the receiving module, and event recording. Additional details pertaining to these protocols and algorithms will be described subsequently.

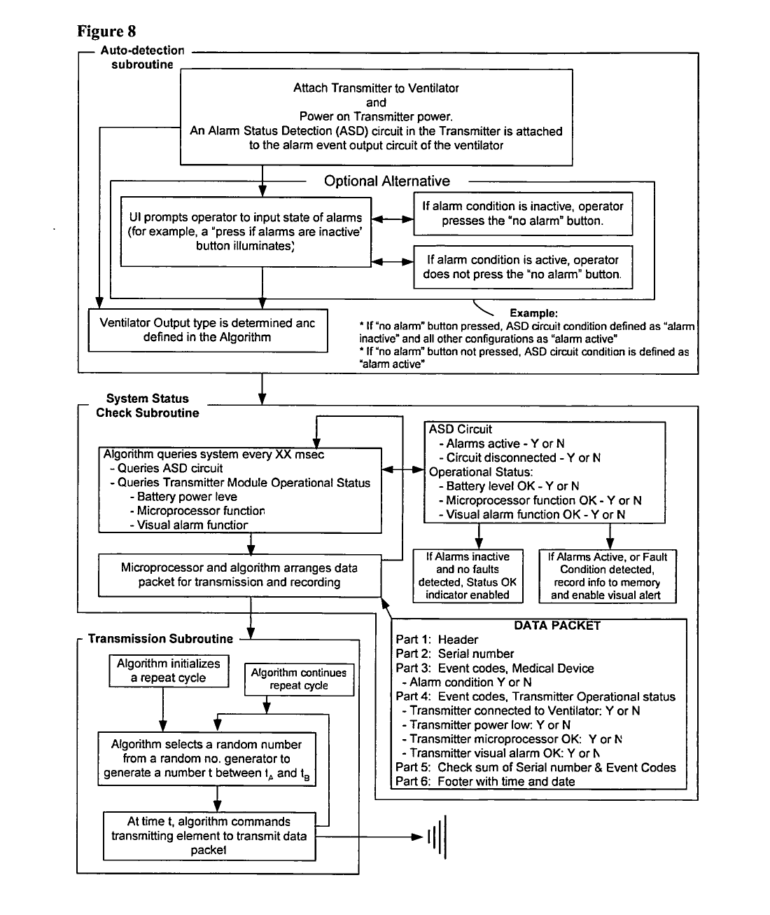

Now referring to FIGS. 8 through 13, the operation of the transmitting module and receiver module is further described. In one aspect of the invention the transmitter module includes the ability to be universally compatible with different medical devices that have different alarm output electrical circuit configurations, and to transmit its signal in a manner that is easy and reliable to receive. For reliable and convenient field deployment of a wireless remote alarm system for a medical device, it is imperative that its compatibility be universal, and its operation be accurate, reliable and easy to use. Otherwise, critical life-threatening user errors and compatibility problems can occur. In additional aspects of the invention, the system is designed to differentiate between types of alarms, consume low power to extend battery life without sacrificing surveillance effectiveness, determine range and signal strength, and be integral to a wide-area communication network to provide useful information to improve the efficiency of management the patient and medical device.

In FIG. 8, a transmitter module data processing protocol and algorithm is described which includes three main subroutines. A first subroutine automatically determines, or alternatively semi-automatically determines, the type of electrical circuit output of the medical device's remote alarm output outlet connector and circuit. For example, the output signal can be a normally open contact when the alarm conditions are inactive, that is no alarms are occurring, or can be a normally closed contact when the alarm conditions are inactive. In this example, a circuit in the transmitter module is coupled to the alarm output circuit of the medical device when the two are physically connected, and an algorithm in the microprocessor of the transmitter module is designed to distinguish between a coupled circuit with a normally open medical device portion versus a normally closed medical device portion. Alternatively, as shown in the Figure, the subroutine may include a user input or secondary automatic input as a redundancy to absolutely confirm the status of the medical device alarms upon immediately after each time the transmitter module is powered ON. For example the user input can be a dual visual indicator and button that prompts the user to select either “alarm active” or “alarm inactive”. This user input, together with the auto-detection of the electrical configuration of the medical device alarm output circuit, will positively confirm the normal alarm inactive and alarm active circuit configurations of the medical device, and therefore allow the transmitter to positively determine the signal characteristic of each state. If the alarm is active immediately following an power ON, the transmitter module remains in a power on self test mode until it detects the simultaneous presence of a change in the alarm output circuit state, indicating that the alarm has cleared, and the enabling of the “alarm inactive” input from the user, as a redundancy to verify the alarm has cleared. In addition to recognizing normally open and normally closed alarm output circuit configurations, the transmitter module circuit and algorithm can recognize other alarm output circuit configurations, such as voltage high and low, current high and low, changing frequency, and other types of electrical circuits and signals that correspond to alarms active or inactive.

In an alternative embodiment of the invention, the transmitter module recognizes the medical device alarm output circuit configuration as follows: when the transmitter is powered on, it assumes the medical device alarm output signal corresponds to “alarm inactive”, and any changes to the circuit by definition correspond to “alarm active”. In order to avoid confusing the transmitter module's logic regarding the alarm status, the user is instructed via labeling, or messaging or training to only turn the transmitter module power ON only if the medical device's alarm status is “no alarms”. The user is also instructed, that if the medical device alarm status is “alarm active” upon power up of the transmitter module, to turn the power of the transmitter module OFF, wait until the alarm condition on the medical device is cleared, then turn the power of the transmitter module ON. The user may be further instructed to power ON the transmitter module routinely, for example at the beginning of every day, when the medical device alarm status is “no alarms”, so as to verify proper synchrony of logic each day. In an additional embodiment, once the alarm output configuration is detected by the transmitter module, it can be stored semi-permanently in the transmitter microprocessor. In this case, a configuration logic master reset switch can be located in a hard to access location, and reset when needed. In this later embodiment, a trained service representative can initially set up the transmitter module for the end user, to avoid any user errors, and the system can be reliably and safely used.

Still referring to FIG. 8, the second subroutine of the data processing protocol and algorithm, system status check, is described. This subroutine performs the following functions: (1) checks the operational status of the transmitting module, (2) checks, displays and if necessary records the alarm output signal status of the medical device, and (3) creates a data package including the serial number, the operational status of the transmitting module, and the alarm output status of the medical device. Checking of the operational status includes checking whether or not the transmitter module is correctly physically connected to the medical device, and for proper power level of the medical device. It may check for other functions such as properly functioning memory and microprocessor and visual indicators. Checking of the alarm output signal status of the medical device includes determining if the alarm output circuit has changed state from an initial state. If the initial state is not changed, the algorithm assigns the alarm status as no change or no incident. Otherwise, if the output circuit has changed state from an initial state, the algorithm assigns the alarm status as changed or “alarm active”. If the alarm status is determined to be active, or if the operational status indicates improper functioning, a data package, described later, is recorded to memory, and a visual alert is enabled. Visual alerts will have different appearances associated with different alarm conditions or operational status problems. For example different color LED's can correspond to different specific alarms or conditions, or different blinking patterns can correspond to different specific alarms or conditions. In addition to recording alarm active events and operational status fault events to memory, a data package will be recorded to memory each time just after the transmitter module is turned on, and each time it is turned off immediately prior to power down.

A current data package is repeatedly created by the protocol at a determined periodicity. The periodicity can for example be every 0.200 seconds, or for example every 3.000 seconds. Typically the current data package may include eight parts as shown in FIG. 11: (1) a header which may include a date and time; (2) a serial number of the transmitter module; (3) an alarm status of the medical device, for example either alarm active or alarm inactive, and including alarm differentiation, for example alarm type 1, alarm type 2, etc., or persistent alarm versus transient alarm, or high priority verses low priority alarm; (4) the operational status of the transmitter module, for example including a code indicating if the connection to the medical device is good or bad, a code indicating if power level is good or bad, and a code indicating if the microprocessor is good or bad; (5) patient call status if the option is included; (6) the transmission time interval or initial transmission time period determined; (7) a check sum of selected sections of the data package; (7) footer which may include time and date information. FIG. 12 shows an example data packet formed by the RM and returned to the TM, to notify the TM if the RM has properly received the transmission from the TM. The TM can then monitor the RM for proper function as a watchdog redundancy.

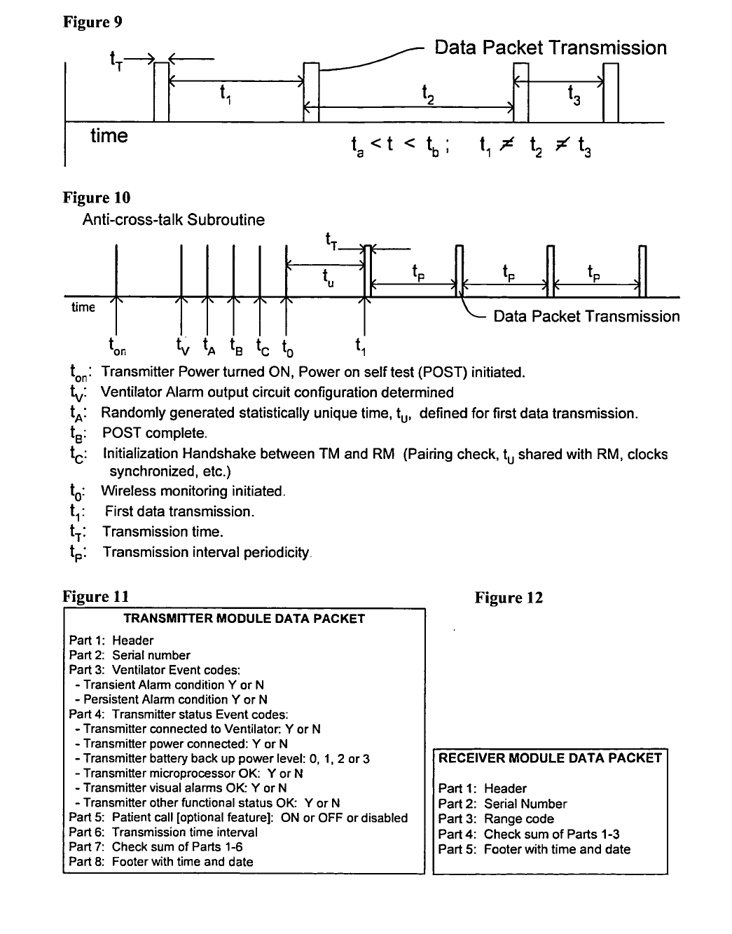

Still referring to FIG. 8, a third subroutine of the data processing protocol and algorithm, transmission, is described. This subroutine determines when to transmit the current data package to the receiver module, and commands the transmitting element to transmit the current data package repeatedly at the determined time. In a preferred embodiment, the algorithm repeatedly transmits the signal at a periodicity of t, and wherein each successive value for t is created by the algorithm and is statistically unique. The value for t which represents the lapse time between transmissions, can for example be created by a random number generator. More than 100 separate and equally probable values for t may be created by the random number generator, and over 50 non-overlapping transmission time windows would be created, and preferably over 1000 and 150 respectively. A range in t values, is selected to minimize the probably of occurrence of the receiver simultaneously processing signals from like transmitters in the transmission zone, given the transmission duration. The range for t values are selected to create a greater than 90% statistical probably that a receiver module will receive only one transmission at a time when there are four other transmitters transmitting to the transmission zone. This unique transmission time prevents the receiver's processor from attempting to read multiple signals at a given instant in time, therefore reducing processing power and bandwidth requirements, and avoiding signal cross-talk and inadvertent read reception at the receiver. An exemplary transmission timing diagram is shown in FIG. 9, showing unique transmission time intervals between each transmission, in order to prevent cross-talk.

Alternatively as shown in FIG. 10, the transmission subroutine may determine a statistically unique first transmission time after power ON, and subsequent to the first transmission, transmit at a constant periodicity. For example, as shown in FIG. 10, the first transmission time can be a time t_{f} selected from a random number generator of between 0.200 sec (tA) to 3.200 sec (tB) after a timer is started after the module is powered ON and performs a power ON self test sequence. After the first transmission, subsequent transmissions can be transmitted at a constant periodicity of for example 3 seconds. If the transmission duration tT is for example 25 msec, 120 unique non-overlapping transmission windows would exist in this example.

The codes used to assign alarm status, system status and fault conditions can be formatted for example in a hexadecimal format, with for example two or three digit ASCII codes representing the respective conditions, or in a binary format. The transmission type can be for example microwave or RF radio frequency. The transmission protocol is typically 19200 bites per second, no parity, 8 bits and 1 stop bit. Typical transmission ranges can be for example 100 meters omni-directionally, and in the range of 100-4000 mHz.

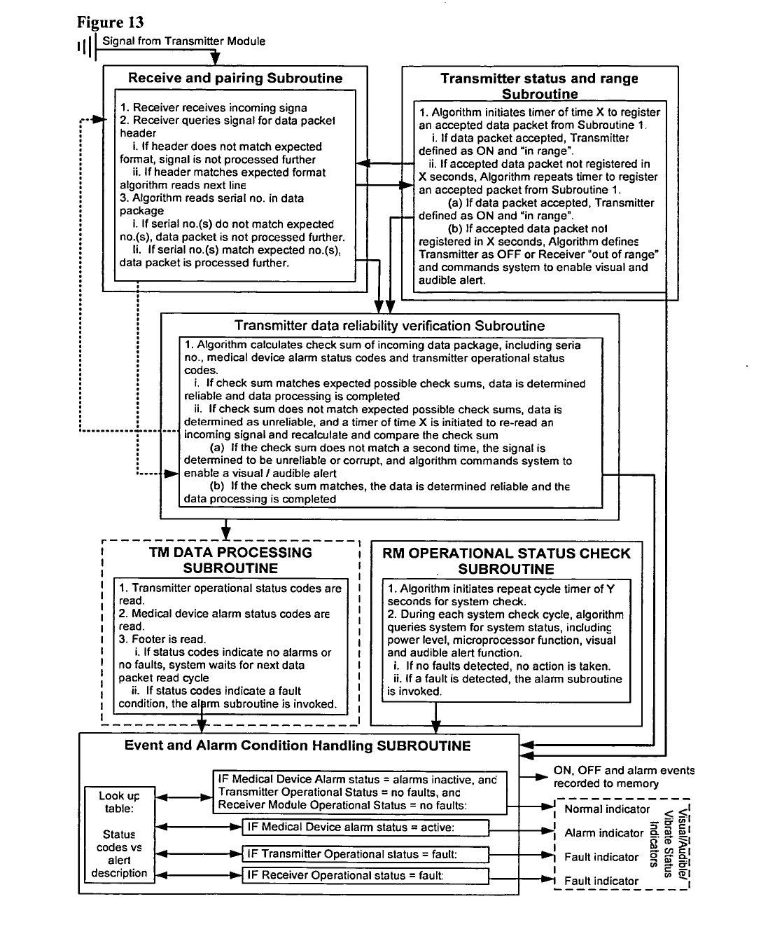

FIG. 13 describes the operation of the receiver module in more detail. A main data processing protocol or algorithm manages the operation of the receiver module. The protocol may be comprised of for example six subroutines. The subroutines may include the following: (1) a subroutine for receiving signals and allowing the processing only of signals that are received from a paired transmitter, (2) a subroutine for determining if the transmitter is within range and turned ON, (3) a subroutine for determining if the transmitted data is reliable, (4) a subroutine for processing the data sent from the transmitter, (5) a subroutine for checking the operational status of the receiver module, and (6) a subroutine for alarm and alert handling, and recording to memory, including enabling visual and or audible alerts to be activated to alert the user.

As a signal is received by the receiver and sent to the microprocessor for processing, the algorithm may first query the signal for a specifically formatted header. If the header is recognized, the algorithm reads the next line of data which is expected to be the serial number of the transmitter, and the algorithm compares the serial number in the signal with the serial number that has been stored in the microprocessor of the receiver module. If a matching serial number is not received over a pre-determined time interval, for example 10 seconds, the algorithm decides that the transmitter is turned OFF or is otherwise non-functional, or that the receiver is out of range of the transmitter. Otherwise, if the serial number in the received signal matches that of the receiver module, the received signal is processed further. The additional processing includes reading additional lines in the signal that correspond to the alarm status of the medical device, and the operational status of the transmitter module, and a check sum of the data. If the check sum does not match expected possibilities of check sums, the algorithm determines that the signal transmission is corrupt, and re-attempts to process an incoming signal from scratch. If multiple successive corrupt transmissions occurs, the algorithm determines that there is a fault with the transmitter and alerts the user accordingly. If the check sum is of a correct value, the algorithm reads additional parts of the data file, which include the medical device alarm output status, and the transformer module operational status. A separate algorithm continually checks the operational status of the receiver module using a repeat cycle loop. Power level, microprocessor function, visual indicator function, audible indicator function, and vibration indicator function are checked, with codes designated for each normal and fault conditions for each function. A next algorithm commands the appropriate systems within the receiver module to visually indicate the operational status of the receiver module, the operational status of the transmitter module, and the alarm status of the medical devise. If there are no alarm conditions active at the medical device, and if the operational status of the transmitter and receiver module is normal, then a visual indicator is enabled to inform the user that the system is functioning properly, and that there are no conditions that require a response. If an alarm condition is detected as active at the medical device, or if the receiver or transmitter modules are detected to have active fault conditions, a unique or specific visual indicator will be enabled for each general category of conditions. For example, if the medical device has an alarm active condition, a red flashing light and fast repeating audible alarm will be enabled. If the transmitter has a fault condition, a yellow flashing light and slower repeating audible alarm will be enabled. Different transmitter faults will be associated with different alarm appearances so that the user can remotely distinguish between different faults. For example, a low power fault will prompt a certain flashing pattern, and an out of range will prompt a different flashing pattern and so on. Different receiver module faults will be associated with different alarm appearances that can be distinguished from one another and from transmitter module fault alarms. For example, a second yellow light can be used, or a different light intensity, or a different color, such as orange. Again, the actual alarm flashing or audible tone or pattern may be different for each receiver module fault condition to allow the user to determine what the problem is. Alternatively, a display screen may be incorporated into the receiver module or the transmitter module which may display in text the alarm and fault status of the medical device, the transmitter module and the receiver module. The algorithms in the transmitter module and receiver module will include look up tables that associate each alarm or fault condition with a unique code, such as a two digit ASCII code. Each time an active alarm condition is detected, or an operational status fault is detected, the algorithm will command the system to record the event with the appropriate codes and with a time and date stamp. The recorded event will include the date, time, serial number, the alarm status of the medical device (alarm active or alarm inactive), the operational status of the transmitter module (separate codes are designated for each condition), and the operational status of the receiver module (separate codes are designated for each condition). An event will also record when the receiver module is powered OFF, just before power shut down, and when the transmitter module is powered OFF, just before power shut down.

In an alternative embodiment of the invention, an alternative technique is used to verify the integrity of the information in the data transmission, to increase reliability and accuracy. The algorithm in the transmitter module calculates a check sum using the medical device alarm status information and the transmitter module operational status information. There are a finite set of potential alarm status conditions, and operational status conditions. Each potential condition is pre-assigned a unique event code. Therefore, there are a pre-defined finite set of potential check sums associated with the all the actual potential conditions, and these pre-defined set of check sums are stored in the transmitter module. The algorithm in the transmitter module, after computing the current check sum, compares the check sum with those stored. If there is not a match, the data is defined as being corrupt. If corrupt data is detected at a rate or incidence greater than a predetermined threshold, the user is notified via an alert that there is a system problem. If there is a match, the data is defined as being reliable and the data is transmitted to the receiver module per protocol. At the receiver module, a similar check is performed on the received data file. The receiver data processing algorithm, once the data file is accepted for processing after the serial number pairing comparison, computes a check sum using the medical device alarm status and the transmitter module operational status information. The check sum is compared to both the check sum transmitted by the transmitter in the data file, and compared to pre-defined check sums stored in the receiver module. Again, if the comparisons do not match, the receiver module defines the data as being corrupt, and if corrupt data is detected at a rate or incidence greater than a predetermined threshold, the user is notified via an alert that there is a system problem. If there is a match, the data is defined as being reliable and the data is further processed according to the event and alarm handling protocol. In addition, the receiver module generates a check sum based on operational status check of the receiver module. Again, a finite set of conditions may exist, and therefore a pre-defined and predetermined set of check sums that are stored in the system. Should the current check sum not match the stored check sums, the operational status check data is defined as corrupt, and if corrupt data is detected at a rate or incidence greater than a predetermined threshold, the user is notified via an alert that there is a system problem.

FIG. 14 describes an alternate embodiment of the invention in which multiple medical devices are set up with transmitting modules and the multiple transmitting modules transmit to a single designated remote wireless portable receiver module. Multiple patients can thus be monitored by a single clinician or caregiver. In this embodiment of the invention, the receiver module is paired with multiple transmitter modules by pairing the serial number of the receiver module with more than one serial number that are each associated with transmitter modules. The data processing protocol in the receiver module is adapted to accept and process signals from multiple transmitters. A different signal processing protocol is associated with each serial number the receiver is paired with, and after a received serial number match is confirmed, the signal is channeled to the protocol associated with that serial number. The visual alarms on the receiver module are identified to be visually associated with specific transmitter modules. This embodiment of the invention is useful in the event that the remote wireless alarm system is being used in a ward such as in a skilled nursing facility where there may be multiple patients being supported by life critical equipment, such as a ventilator ward.

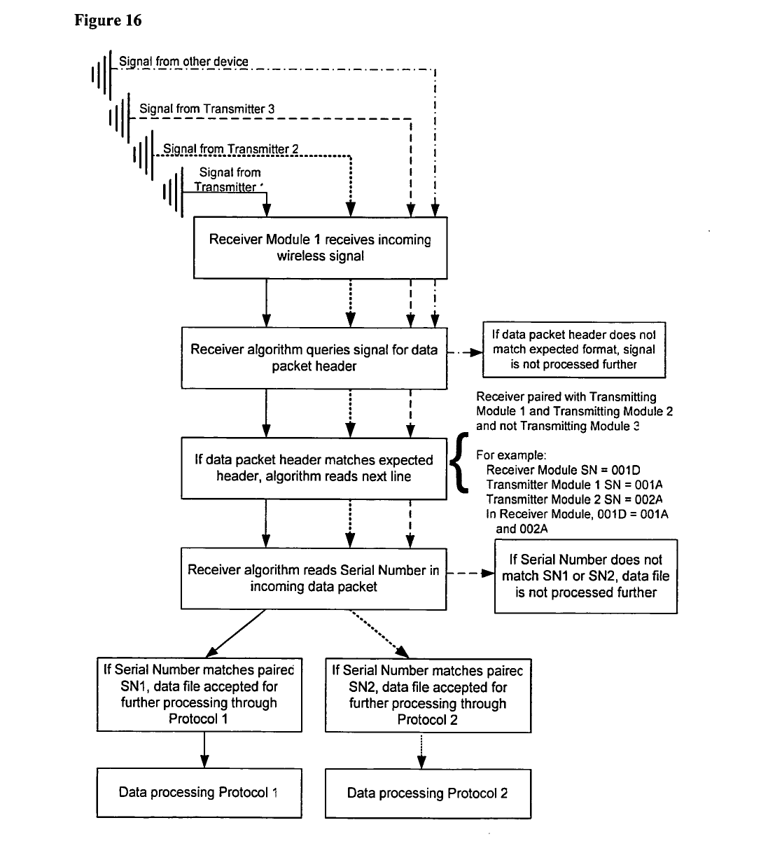

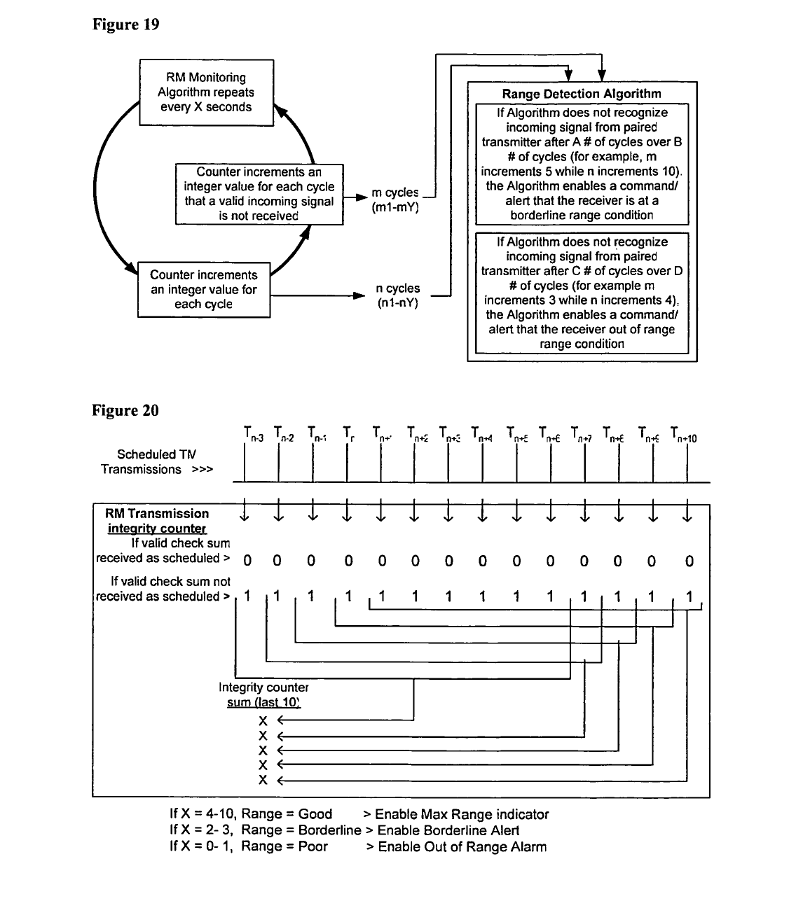

FIG. 15 describes a schematic view of the receiver module used in the multiple transmitting module application described in FIG. 14. Multiple transmission signals can be recognized and accepted by the transmitter signal processing protocols, and then processed appropriately. Visual alerts visually associated with the different transmitting modules are provided, so the caregiver can associate an alarm event with the correct patient or medical device or transmitter module. A separate receiver module fault visual alarm is provided, for example for low battery power of the receiver module. FIG. 16 shows schematically how the receiver module signal and data processing protocol may operate. Wireless signals recognized by the receiver are checked against expected identification. If the signal does cannot be identified for example by serial number pairing, the signal is not processed further. If the signal is recognized, it is sent to the appropriate processing protocol in the receiver module that corresponds to the patient and medical device in question, for processing separate from and unrelated to other signals and other medical devices and patients. Ultimately the status of the device and patient in question as well as the corresponding transmitter will be displayed to the user, as described further in FIGS. 11 and 19.

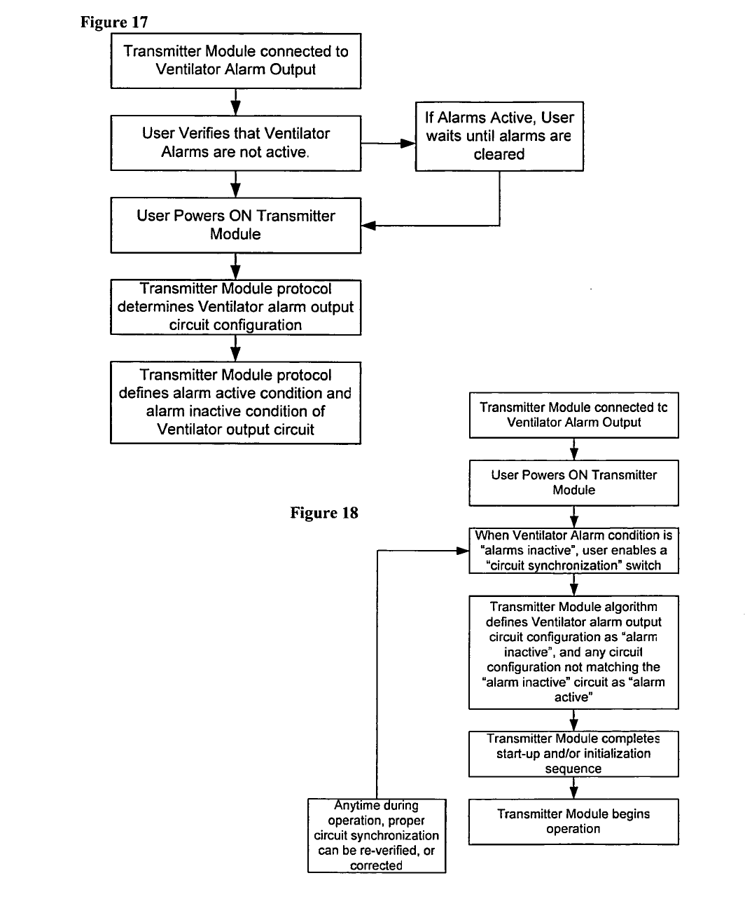

FIG. 17 schematically describes an alternate embodiment of the invention for detecting the alarm output circuit configuration of the medical device. In this embodiment, the user or service personnel is instructed to power on the transmitter module when the alarm status of the medical device is alarms inactive. The signal processing protocol in the transmitter module then assigns that circuit configuration to “alarms inactive” and by default assigns any other circuit configuration not matching the “alarms inactive” configuration as “alarms active”. The user can be trained, or instructed to follow this power ON sequence. The sequence can be repeated if the user determines that the remote alarm system is not properly synchronized with the actual ventilator alarm status.

FIG. 18 schematically describes an alternative configuration of the invention for detecting the alarm output circuit configuration of the medical device. After connection to the medical device and power on of the transmitter module, the user is instructed to enable a “circuit synchronization” switch. For example, the user presses a synchronization button when the ventilator alarm condition is “alarms inactive”. When the button is pressed, the signal processing protocol or algorithm in the transmitter module assigns the circuitry at that time as “alarms inactive” and any circuitry configurations not matching that configuration as “alarms inactive”. The procedure can be repeated at any time, for example once a day, or anytime there is a concern as to the proper synchronization between the ventilator alarm circuit and the transmitter module logic.

FIG. 19 schematically describes an alternate embodiment of the invention in which signal processing protocol determines the condition of the range between the transmitter module and the receiver module. In this embodiment one or more range conditions can be determined. In the example shown, three different range conditions are shown; (1) receiver is at a borderline range condition, (2) receiver is out of range, and (3) receiver is within range. The range status can be determined by comparing (a) the number of signal processing cycles that the receiver recognizes a signal from a paired transmitter, to (b) the total number of signal processing cycles elapsed for a given time period. For example, if the receiver recognizes a signal from a paired transmitter 25-75% of the signal processing cycles, it assigns the position of the receiver as “borderline” and for example alerts the user with a low level alert. If the receiver recognizes a signal from a paired transmitter less than 25% of the signal processing cycles, it assigns the position of the receiver as “out of range” and for example alerts the user with a high priority alarm. If the receiver recognizes a signal from a paired transmitter more than 75% of the signal processing cycles, it assigns the position of the receiver module as “within range” and indicates to the user that the system status is normal or OK. A similar protocol can be used to determine if the signal received from the transmitter is corrupt or intact, for example by comparing check sums described earlier, rather than comparing serial numbers or pairing between the transmitter and receiver.

FIG. 20 describes a timing diagram of a range detection protocol. In the example shown, zero's or one's are assigned by the RM each time the RM expects to receive a transmission for a received and a not received transmission respectively. The sum of the assigned values over a number of expected transmissions is compared against threshold values to determine if the RM is within range of the TM, and if it is at a borderline range.

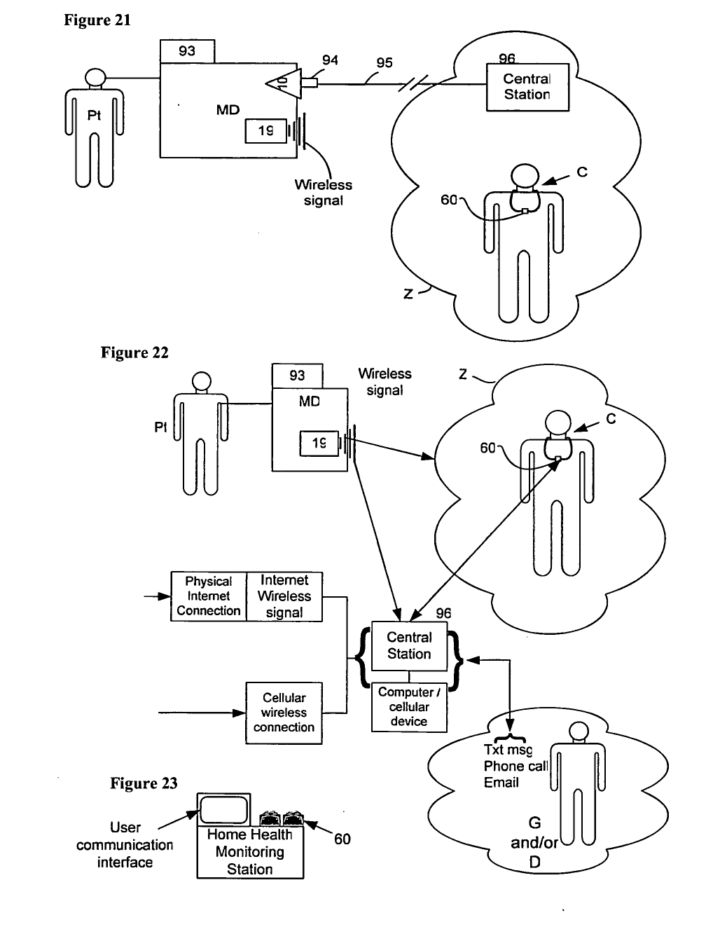

FIG. 21 describes an embodiment in which the transmitting module is integrated into the medical device, such as a ventilator. In addition, a remote wireless alarm unit can be used simultaneously with a hard wired remote alarm unit. For example, a hard wired alarm can be positioned at the nursing station, or in a room in a house, while a wireless remote alarm unit can be carried around with the clinician or caregiver to other rooms. The wireless signal from the medical device can alternatively be transmitted to the central station and the central station can indicate to a person manning the station, and also transmit to the clinician or caregiver. For example the TM may transmit to a stationary receiving station, and the receiving station may transmit to the wireless remote receiver module.

Also described in FIG. 21 is a docking station 93 associated with the medical device MD. The docking station may serve as a storage location for the remote wireless alarm receiver, and may also serve as a charging station, as well as a diagnostic test station. Alternatively, the TM may include a docking and charging station for the RM. The stored alarms in the receiver module and the transmitter module can be downloaded by physically attaching a memory access device, such as a thumb drive with a software application allowing it to copy the stored data in the module. Or the stored alarm or event information can be transmitted to an external device wirelessly and or automatically such as through WIFI internet, a cell phone network, or through telemetry.

FIG. 22 describes a main embodiment of the invention in which the medical device alarm monitoring system is integrated into a wider area wireless network, typically to a PDA or computer directly or indirectly through an intermediary device. The wireless signal is transmitted from the medical device transmitter 19 to a central station 96, and from the central station to a remote person via text messaging, phone call, or email. The remote person is typically a guardian or clinician who is responsible for or interested in the care of the patient. The wider area wireless network can help the remote person manage and optimize the efficiency of care of the patient, and prevent costly episodes by intervening preventatively as needed based on the monitored information. FIG. 23 indicates an alternative aspect of that described in FIG. 22 in which the medical device alarm monitor system is integrated into a home heath monitoring station (HHMS), such as the Health Mate™ or Health Buddy™. Wireless RM's 60, in communication with the medical device, can be docked with and interface with the HHMS. The user, such as the caregiver, can interact with remote clinicians through the communication interface to help manage and optimize the efficiency of the patient's care. The medical device alarm status indicator can be an important tool in the overall management of the patient, by using the alarm information to identify and understand any issues surrounding the medical device and patient related to treatment provided by the medical device. For example, with a left ventricular assist device, a frequent pacing alarm may indicate that there is a problem with lead placement that needs to be corrected, that if not corrected, could result in a very serious and/or costly critical situation, hospitalization or exacerbation. Alternatively, the alarm monitoring system may include a database of alarm codes for different brands of medical devices, and a menu for the user to select the brand of medical device to which the system is being connected to. Alternatively, the system includes a protocol for the user to download from a wireless or wired communication network, or input through an input device, a set of medical device alarm codes for the medical device, typically for example from the manufacturer or service provider, in order to synchronize the operation of the alarm system to the alarm output configuration of the medical device.

In a similar application of the invention, a patient may be mobile with the medical device, for example, the patient may be at a care center or special education facility. The TM portion of the alarm monitoring system may include or transmit to a cellular or Internet enabled device, and send the transmission to a remote person, such as a guardian, to notify the remote person that an alarm condition has occurred.

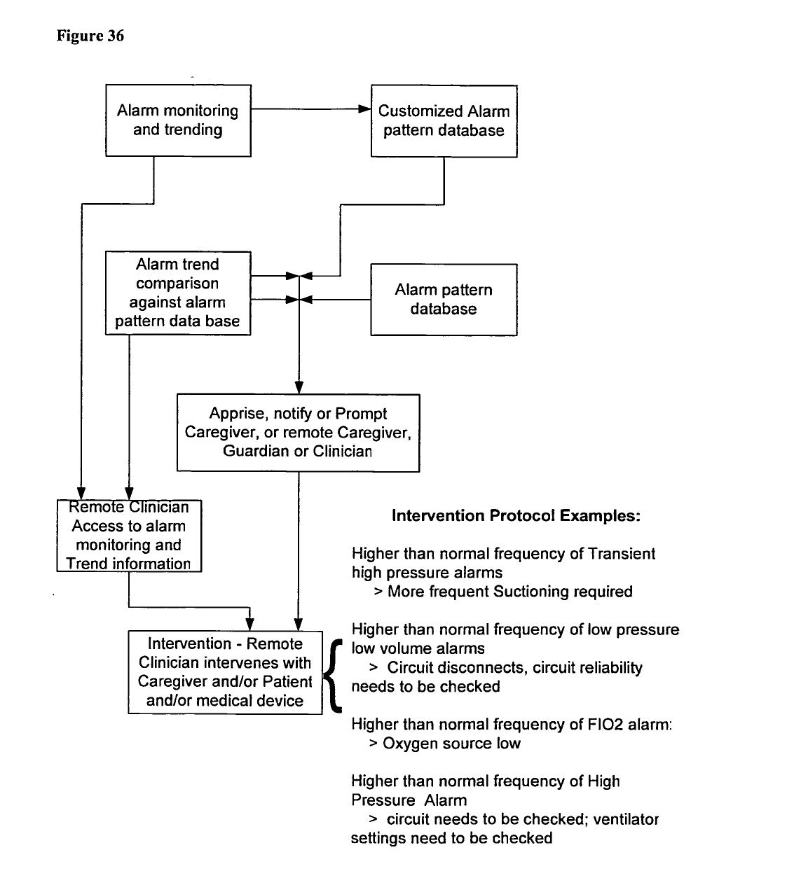

FIG. 36 describes an example of how the wider area network can be used to manage the efficiency of care of the patient when the system is used to monitor and manage homecare ventilation. Customized alarm pattern thresholds can be established and/or threshold databases can be used, and compared to the actual alarm information, and the clinician can preventatively interdict in the care is required.

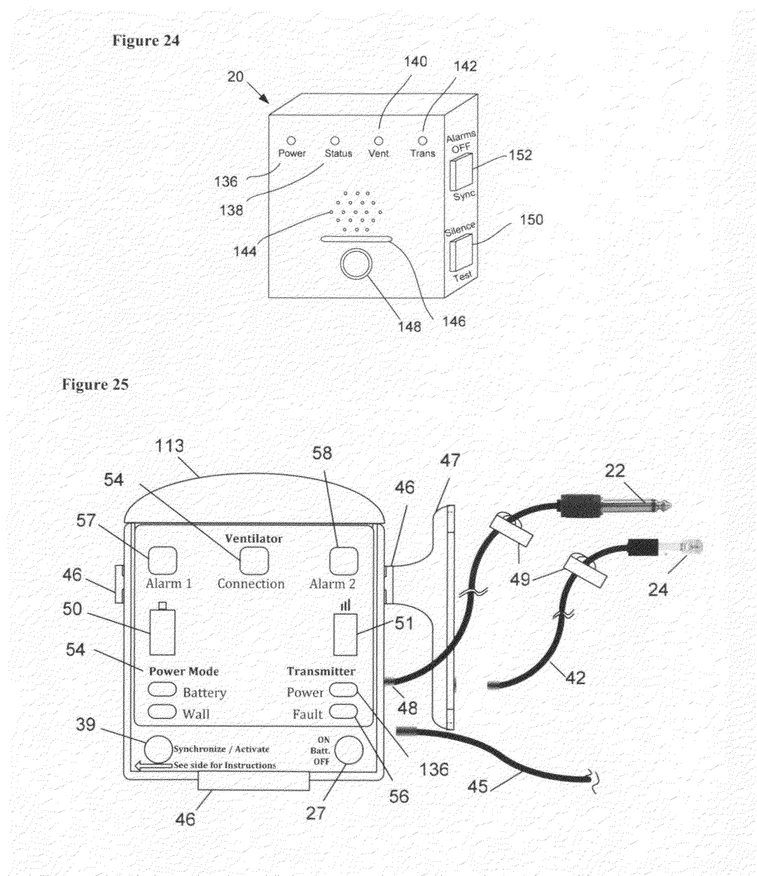

FIG. 24 describes an example of the user interface of a transmitter module. The module may have an audible alarm to annunciate a fault condition with the transmitter module itself. The transmitter module may have an array of visual indicators for identifying the status condition of the medical device and the transmitter module. Alternatively, it can have an indicator for indicating if the receiver module is within range of the transmitter module, for example to notify the patient if the caregiver is within range. It may have a power on indicator, such as a blue LED. It may have a System Status indicator such as a green LED that is lit as long as the system status is OK and there are no alarms or fault conditions with the ventilator or transmitter module respectively. This indicator provides a positive indicator that the system is functioning correctly, for example, a broken Ventilator Alarm LED can be indicated by the Status LED being unlit or blinking, or some other pattern. If there is an alarm or fault condition, the System Status indicator changes, for example turned off, and the appropriate indicator is illuminated, for example the ventilator or transmitter indicators. The different alarm or fault indicators may be red LED's and may have different illumination patterns based on different conditions. For example, a low power condition may be indicated by a slow blinking Transmitter LED versus a disconnection with the ventilator may be indicated by a fast blinking Transmitter LED, versus a fault condition within the Transmitter module, such as a faulty microprocessor may be indicated by a solid non-blinking Transmitter LED.

FIG. 25 describes an alternative user interface and user features of the TM when used for ventilator monitoring. A dome light visual indicator is provided, a ventilator mounting bracket, a power cord or alarm cord bracket, high priority and low priority ventilator alarm indicators, a ventilator connection status or fault indicator, battery power and range gauges, a power mode indicator, transmitter function status indicator, a button to synchronize the TM to the ventilator's alarm status, an ON/OFF and battery button, separate cord sets for a phono style and phone style ventilator connectors, and power cord set. Power ON when powered from the wall can be indicated by a green blinking Power visual indicator and a green blinking Wall visual indicator. When the unit is disconnected from the wall power, or during a power outage, the unit will alarm by illuminating the Power visual indicator red, until the user for example presses the ON/Batt./OFF button to signify that the unit is being placed in Battery mode. When operating in Battery mode, ON status will be indicated by a green blinking Battery visual indicator. The system can be tested by momentary pressing of the ON button

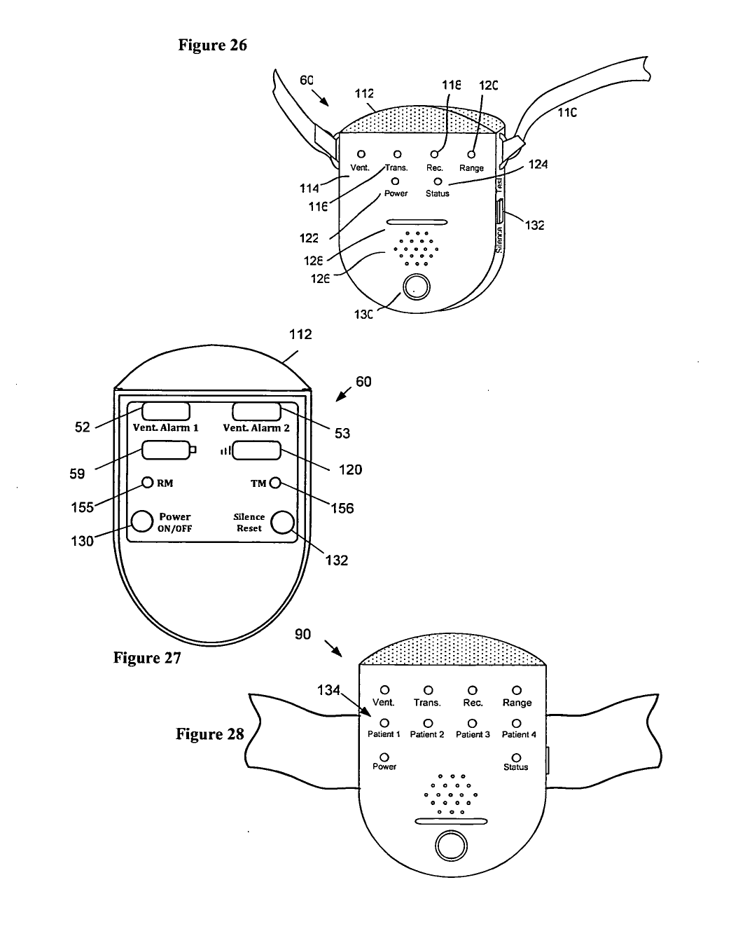

FIG. 26 describes an example of the user interface of a receiver module. The module typically includes an audible alarm and visual alarms. A large primary visual alarm indicator 112 may be included, for example a large lens that illuminates red or orange during an alarm condition. The large primary visual alarm indicator 112 is designed so that a user will notice the indicator when it is lit regardless of viewing angle or positioning of the receiver module. A bulbous shape as shown is one exemplary way in which to accomplish this. It can blink on and off to conserve power. Smaller less noticeable indicators, such as LED's may be included to inform the user as to the specific nature of an alarm condition. Such indicators can be included for the ventilator alarm status, the transmitter module functional status, the receiver module functional status, and the range status between the transmitter and receiver. Different illumination patterns of the indicators can be used to notify the user as to the nature of the alarm or fault condition. For example, a slow blinking range indicator can indicate that the range is borderline and a fast blinking range indicator can indicate that the range is out of range. Alternatively, the large visual alarm lens can be illuminated by different colored LED's, and different colors can correspond to different alarm or fault conditions. For example a flashing red may indicate a ventilator alarm condition, a flashing blue may indicate a transmitter module fault, a flashing yellow may indicate a receiver module fault, and a flashing orange may indicate a range problem. A power on indicator and System Status indicator may also be provided. In the example shown a lanyard is provided to wear the receiver module around the neck. A speaker screen is provided with a boss to prevent inadvertent obstruction of the speaker screen. Alternatively, a second redundant speaker can be included, and invoked in the alarm handling protocols if the primary speaker is determined to be faulty through diagnostic testing. Similarly, a secondary redundant diode can be invoked if the primary diode that illuminates the alert lens is determined to be faulty. An ON/OFF button is provided with a guard to prevent inadvertent activation. An alarm silence/reset/test button is provided in a location that resists inadvertent activation.

FIG. 27 describes an alternative user interface of the RM. A dome light visual indicator provides a noticeable status indicator of the alarm status, if a fault or alarm condition is active. Battery and RM range status or signal strength visual gauges or indicators are provided, for example with a green blinking light for maximum Battery and signal strength, a blinking yellow light for about 50% battery power and medium strength signal, and a blinking red light for critically low battery power and critically weak or out of range signal. Receiver and Transmitter internal fault indicators can be provided. Power ON status can be indicated by the Battery and Signal Strength indicators blinking.

FIG. 28 describes an example of the user interface of a multi-patient receiver module. There may be more than one patient indicators in addition to the alarm and fault indicators. If for example the ventilator being used on patient 2 has an alarm condition, then the Ventilator indicator is lit and the Patient 2 indicator is lit. In an alternative embodiment of the invention, a signal receiver module can be used to track the alarm status of multiple medical devices used on one or more patients. For example, a receiver module can have notify a care giver of the alarm status of a ventilator and a heart monitor for a single patient. In this example, one transmitter module can be universally compatible with connecting to and synchronizing with the alarm output configurations of both the ventilator and heart monitor. The transmitter module and the receiver module can include the requisite separate signal processing protocols for the ventilator and the heart monitor. The receiver module will distinguish between alarm and fault events with the ventilator, the heart monitor and the transmitter module. For example, if the heart monitor is in an alarm condition, the receiver module's alert lens will illuminate, the audible alarm will activate, and the Heart Monitor indicator will illuminate notifying the caregiver that the problem is with the patient's heart.

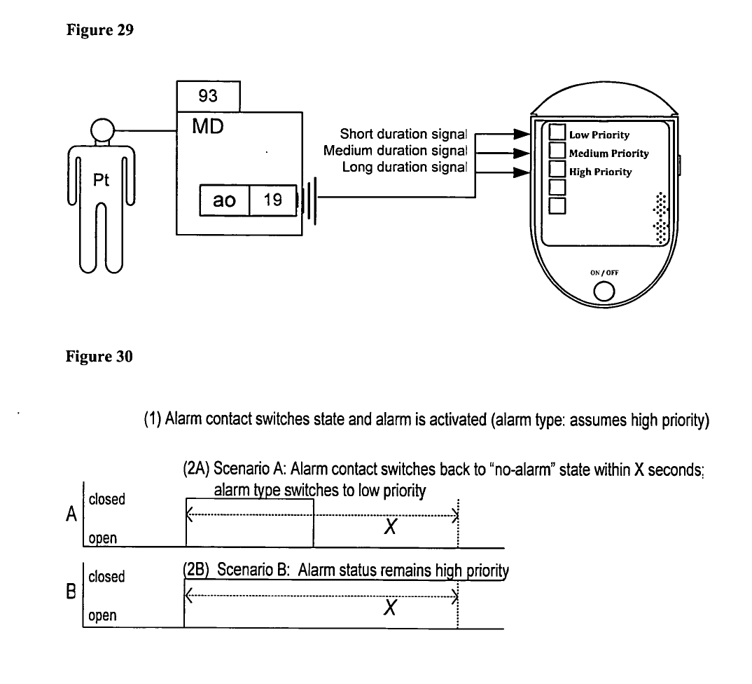

FIGS. 29-33 describe algorithms and techniques for the remote alarm monitoring system to differentiate between different types of alarms of the medical device, or to define or differentiate between different importance levels of the alarms. If FIG. 29, a medical device's alarm output status is transmitted to the remote RM, for example a normally open contact is closed. The duration that the closed contact is closed will be correlated to different types of alarms, based on knowledge of alarm behavior, or will be correlated to low, medium and high priority alarms. The respective alarm type or alarm priority will be indicated on the wireless remote RM, and notify the user not only that the medical device is in an alarm condition, but what or how important the alarm condition is. FIG. 30 shows the differentiation protocol of FIG. 29 as a function of time. An alarm type B is assumed upon the initiation of an alarm condition. At time X, if the alarm status remains active based on the closed contact, the alarm will remain classified as a high priority alarm. If the alarm closed contact switches back to the open condition before time X, then the protocol assumes the alarm was of type A and was a transient alarm of lesser importance that alarm B, and the alarm is classified as low priority, or identified as one of a list of transient alarms.

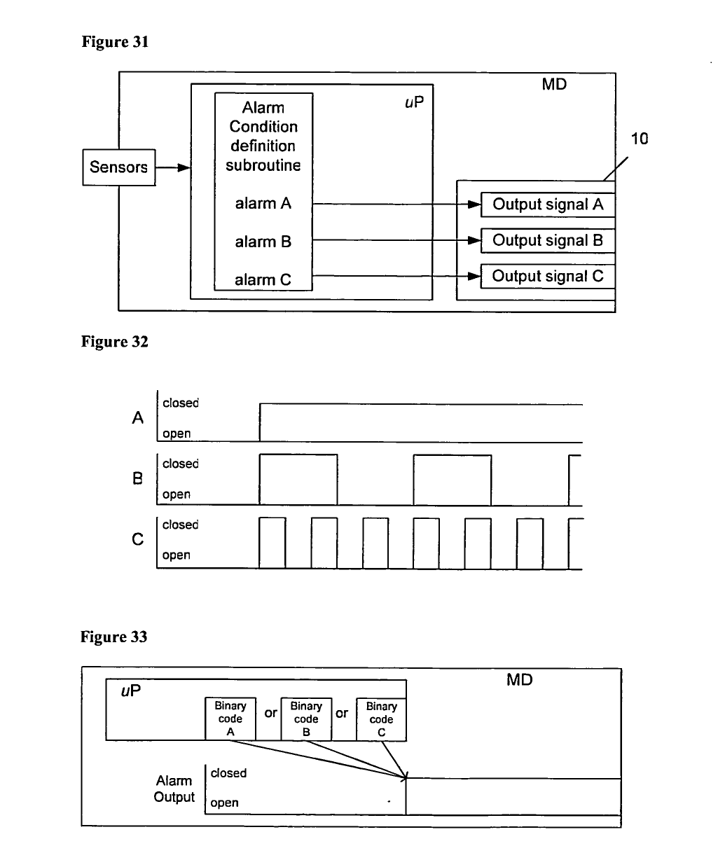

FIG. 31 describes a medical device in which the microprocessor receives inputs from the medical device's sensors and assigns alarm specific alarm codes to each different type of alarm. For example there may be three types of alarms, A, B and C. The microprocessor will then deliver the alarm specific code to the alarm output of the medical device, so that the alarm monitoring system knows what the alarm is. For example, in FIG. 32, a medical device alarm output is a normally open contact that closes when the alarm condition is active, however, in which the contact cycles from open to closed at a frequency unique to the alarm type. For example, for alarm type A the contact remains closed for the duration of the alarm condition; for alarm type B the contact cycles from open to closed at a medium frequency; for alarm type C, the contact cycles from open to closed at a higher frequency. By reading the frequency of opening and closing of the alarm contact, the TM can distinguish between alarm types A, B and C, and notify the caregiver via the RM exactly which alarm type is occurring, or optionally notify a person or the trending database in the wider area network monitoring system.

FIG. 33 describes a medical device in which the microprocessor assigns codes to each type of alarm, and transmits that code through the alarm output, for example when a normally open alarm output closes when an alarm condition occurs.

FIGS. 23A and 23B describe a remote wireless medical device alarm system with a power management protocol. The protocol includes a non-continuous power duty cycle of the transmitter and receiver, in order to conserve power consumption of the wireless battery operated receiver module and optionally also the transmitter module, if battery operated.

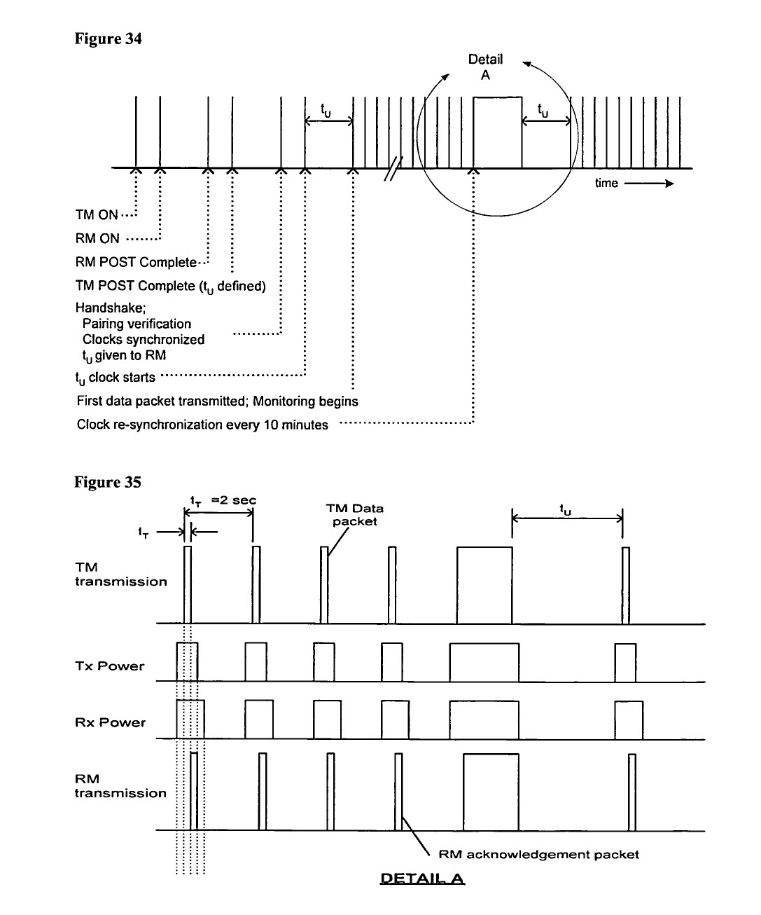

FIG. 34 shows a timing diagram of the transmitter and receiver module superimposed on the same time scale on the horizontal axis, with the signal transmission signal pulses indicated on the vertical scale. The alarm status monitoring phase begins at time tu after the tu clock starts. FIG. 35 shows the timing diagrams of the transmission and reception, and of the power applied to the transmitter and receiver elements Tx and Rx. Power is only applied to the Tx and Rx for a window of time surrounding the scheduled transmission. Alternatively, low power is applied when the Tx and Rx are not transmitting or receiving to place the Tx and Rx in standby mode, and full power applied when they are transmitting and receiving. By not applying full power to the Tx and Rx at a continuous duty cycle, the power they consume can be reduced by 10-50 times, depending on the transmission periodicity and transmission time. At time tT the TM transmits the data packet. Prior to tT, power is applied to the Tx and Rx, and after tTI, the power is removed. The RM can also transmit a return acknowledgment signal before within the power on window. In this case the Tx and Rx are both transceivers to both transmit and receive signals. The power-on window of one of the Tx or Rx is typically greater than the other to account for tolerances in the system. Optionally, the power management protocol includes a re-synchronization step at certain intervals, in order to verify that the TM and RM clocks are synchronized, for example, every five minutes, so that the power on cycles do not become asynchronous over time. Alternatively, the transmission interval and Tx and Rx powering interval can be a randomly changing number such that the period between powering and transmissions is statistically unique from the previous period. In this case the randomly generated transmission interval for the next transmission is determined before the previous transmission, and shared between the TM and RM in the previous transmission so that both the TM and RM are reset to transmit at the correct time. Alternatively, the power to the Tx and Rx is powered down after the TM receives acknowledgment from the RM that the transmission has been received, rather than a predetermined power down time.

The system may comprise (a) a transmitter module adapted to: (1) determine the actual configuration of the alarm output circuit of the medical device from a plurality of potential configurations; (2) repeatedly create and transit an alarm status data package corresponding to the alarm status of the medical device; (b) a wireless receiver module paired to at least one transmitter module and adapted to: (1) determine if a received signal is from the at least one paired transmitter module and adapted to process the received signal if a received signal is determined to be from the paired transmitter module, and (2) verify that the receiver module is in range of the transmitter, and (3) control an indicator to indicate the alarm status of the medical device. The system includes an alarm differentiation protocol and connectivity to a wide-area communication network and comprising patient management protocols. The system includes a transmitter and receiver comprising a power management protocol to operate the transmitter and receiver at a cyclical duty cycle timed to correspond to a transmission event. The system includes a circuit adapted to determine the medical device's actual alarm output configuration, wherein the determining is automatically performed by automatically assigning an alarm inactive normal state upon detection of continuity between the medical device and transmitter module. The transmitter module further may comprise a circuit adapted to semi-automatically determine the medical device's actual alarm output configuration, wherein the semi-automatic determination may comprise a function configured to accept an alarm status input from a user. The system further may comprise a routine to determine the circuit configuration of the medical device alarm output circuit, the routine comprising the steps of: (1) powering the module ON, (2) connecting the module to the medical device alarm output connector and verifying a connection is made, (3) prompting the user to enable an input to the module wherein the input is either “alarm active” or “alarm inactive”. The system further may comprise a routine to determine the circuit configuration of the medical device alarm output circuit, the routine comprising the steps of: (1) powering the module ON, (2) connecting the module to the medical device alarm output connector and verifying a connection is made, (3) prompting the user to verify that the medical device alarm status is “no alarms active” and prompt the user to enable an input to the module to confirm that the medical device alarm status is “no alarms active”. The transmitter module may comprise an algorithm adapted to (1) recognize the medical device output circuit configuration, (2) define the output circuit configuration as “alarms inactive” when the medical device alarm status is “no alarms active”, and (3) define a change to the defined “alarms inactive” output circuit configuration as “alarms active”. The transmitter module may comprise a plug system adapted to connect to the medical device alarm output outlet connector, wherein the plug system may comprise universal adaptors to compatibly attach to a plurality of outlet connector configurations.

The system also includes a Transmitter Module protocol to verify the operational status of the Transmitter Module, and a Receiver Module protocol to verify the operational status of the Transmitter Module, and a Receiver Module protocol to indicate to the user the operational status of the Transmitter Module and the Receiver Module; and wherein the operational status is one or more functions selected from the group of power level, connectivity, microprocessor function, alert and message indicator function. The system further may comprise an algorithm adapted to transmit the alarm status data package at transmission times that are substantially statistically unique from like transmitter modules, the substantially statistically unique transmission time created by setting the periodicity, or time between two consecutive transmissions, with a number that is generated by the algorithm, where the number is statistically improbable of being repeated for at least 50 repeat cycles. The system may comprise an algorithm adapted to transmit the alarm status data package at transmission times that are substantially statistically unique from like transmitter modules, the substantially statistically unique transmission time created by setting the time for the first transmission at a statistically unique time using a number generated by the algorithm, and subsequent transmission times at constant periodicity. The system can be used with a respiratory ventilator, a cardiac support device, cardiac monitoring device, an incubator, an infusion system, a heart-lung support system, or a kidney support system. A system receiver module can be paired with multiple transmitter modules to monitor multiple patients receiving care from multiple medical devices. The system receiver module can be configured to monitor multiple medical devices used to treat a single patient. The transmitter module can be integrated into the medical device or modularly attached to the medical device. The system can comprise a docking station adapted to perform one or more of the following functions: store the receiver module, charge the power of the receiver module, perform diagnostic testing of the receiver module, download data stored in the receiver module. The serial number of the transmitter is transmitted by the transmitter, and the receiver module posses a paired serial number, and the receiver module algorithm queries received signals for the paired serial number from the transmitter, and in the absence of detecting a received signal with a paired serial number determines that the receiver module is out of range of the transmitter module or that the transmitter module power if OFF.

The receiver module may comprise an algorithm adapted to create a check sum which is comprised of the current alarm status and the transmitter operational status information contained in the received transmission, and wherein the created check sum is compared to a set of predetermined check sum values, and wherein the comparison is used to verify that the data in the received transmission is acceptable. The transmitter module and receiver module comprise a protocol adapted to verify that the transmitted and received signal is reliable, the protocol including an arithmetic summing of parts of the transmitted data packet. The receiver module further may comprise a reception range determination algorithm, the algorithm adapted to read an incoming signal on a repeating cycle and adapted to determine one or more of the following range conditions: within range, out of range, and borderline in range, wherein the range condition is determined by comparing (a) a number of signal read cycles with (b) a number of signal read cycles in which a paired serial number was detected. The system may comprise a receiving data packet reliability determination algorithm, the algorithm adapted to read an incoming signal on a repeating cycle and adapted to determine if data is reliable or if data is unreliable by comparing (a) a number of signal read cycles with (b) a number of signal read cycles in which an arithmetic sum of parts of the data packet matches an expected sum. The transmitter module records the alarm status from the medical device and the transmitter operational status when the alarm status is “alarm active” or when the operational status indicates a fault condition. The receiver module records the alarm status from the ventilator, the transmitter operational status, and receiver operational status, when the alarm status is “alarm active” or when the transmitter module operational status indicates a fault condition or when the receiver module operational status indicates a fault condition. The receiver module may comprise a user interface, the user interface comprising one or more of the following: a master visual alert adapted to visually indicate any alarm or fault condition, specific visual alerts adapted to indicate the nature of the alarm or fault condition, a power status indicator, a system status indicator. The receiver module may comprise a user interface, the user interface comprising: (a) alert indicators associated with the medical device alarms, transmitter operational status, receiver operational status, range, and (b) visual indicates associated with individual different patients. The receiver module may comprise a primary and secondary speaker to audibly communicate an alert, and comprising a circuit to check the operation of the primary speaker, and to invoke the use of the secondary speaker if the primary speaker is determined to be faulty. The receiver module may comprise a master visual alert illuminated by an light element, to visually communicate an alert, and comprising a circuit to check the operation of the light element, and to invoke the use of the secondary light element if the primary light element is determined to be faulty. The receiver module is configured to be worn by a caregiver, the configuration selected from the group of a lanyard, a wrist band, an arm band, a waist band, a belt clip, a pocket clip, pocket size. The receiver module is adapted with a magnet to position the module on a metallic surface.

The system may comprise (a) a transmitter module comprising; a connector adapted to connect to an alarm output of the medical device, a connection to a power source, a wireless transmitting element; a microprocessor containing a serial number of the transmitter module and an algorithm: a circuit adapted to transfer the alarm events output signal from the medical device to the microprocessor algorithm; and wherein the algorithm is adapted to: 1) determine the actual configuration of the alarm output circuit of the medical device from multiple potential configurations, and 2) repeatedly query the transmitter module operational status including power level and medical device connection, and 3) repeatedly create a current alarm events status data set based on the alarm events output from the medical device, and 4) repeatedly create a current data package including the serial number, the operational status of the module, and the current alarm events status of the medical device, and 5) command the transmitting element to repeatedly transmit the current data package at times that are substantially statistically unique from like transmitter modules; (b) a wireless receiver module comprising; i. A wireless receiving element adapted to receive the transmission from the transmitter module; ii. A microprocessor containing a serial number of the receiver module matched with the serial number of a transmitter module, and an algorithm; iii. A circuit adapted to communicate data received by the wireless receiving element to the microprocessor algorithm, and wherein the algorithm is adapted to; 1) query the receiver module operational status including power level, and 2) process the current data package including: compare the serial number of the transmitter module to the serial receiver module, and if the serial numbers match, process the operational status of the transmitter and the current alarm status of the medical device, and 3) verify that the receiver is in range of the transmitter by successfully reading a serial number in a current data package that matches the receiver module serial number within a selected time window, and 4) command the microprocessor to trigger an indicator on the receiver module to indicate the receiver module operational status, the transmitter module operational status, the medical device alarm output status, and the in range or out of range status of the receiver module.

As part of the present invention, it should be noted that the embodiments and elements described in the specification can be applied to the invention in part and in any reasonable combination, and for brevity not all such permutations and combinations are explicitly described.

1. A wireless system to monitor the alarm event status of a medical device with an alarm output and alarm output connection selected from a group of medical devices, the system comprising:
(a) a first transmitter module comprising a connection adapted to connect to the alarm output connection of a medical device selected from the group of medical devices, and further comprising:
(1) a circuit configuration detection algorithm adapted to determine the electrical circuit configuration of the alarm output of the medical device from a plurality of potential configurations;
(2) an alarm status determination algorithm adapted to determine the alarm status of the medical device from a plurality of potential alarm statuses;
(3) a transmitter element with a wireless transmission range and a third algorithm adapted to repeatedly create and wirelessly transmit an alarm status data package corresponding to the alarm status of the medical device;
(b) a wireless receiver module paired to wirelessly communicate with the first transmitter module and further comprising:
(1) a receiving element adapted to receive wireless signals;
(2) a handshake algorithm adapted to determine if a received signal is from the first transmitter module;
(3) a signal processing algorithm adapted to process the received signal if the handshake algorithm determines the signal is from the first transmitter module;
(4) a user interface adapted to communicate the alarm status of the medical device to a user based on the processed received signal.

2. A system as in claim 1 wherein the receiver module further comprises a range algorithm adapted to determine if the receiver module is in range of the transmitter element, the range algorithm comprising logging the transmission receiving events and comparing the logged events with a reference value, and correlating the comparison to a range.

3. A system as in claim 1 further comprising an alarm differentiation protocol, wherein the protocol differentiates between a first alarm type and a second alarm type based on an alarm signal parameter selected from the group: alarm duration, alarm persistence, alarm repetitions, alarm frequency, alarm signal amplitude, alarm codes.

4. A system as in claim 1 further comprising:
(a) A wireless device to connect the system to a wide-area communication network;
(b) A protocol to convey the alarm status to the wide-area communication network;
(c) A patient management protocol comprising an alarm status data monitoring protocol and a user interface to convey alarm information to a user.

5. A receiver module as in claim 1 further comprising a power management protocol, the protocol comprising cycling the power applied to the receiving element between a first operating power and a second lower power.

6. The system as in claim 1 comprising a transmission security and power management protocol comprising the following a handshake protocol within the transmitter and receiver module comprising:
(a) a time algorithm to determine a statistically unique time value;
(b) a transmitter module power and transmit algorithm to apply power to the transmitter element and transmit at the statistically unique time value;
(c) a receiver module power and receive algorithm to apply power to the receiving element and receive at the statistically unique time value.

7. The system as in claim 1 comprising a transmission security and power management protocol comprising the following:
(a) a transmitter module and receiver module synchronization protocol designed to synchronize the transmit time and the receive time at a repeating time value that is statistically unique;
(b) a transmitter module protocol and a receiver module protocol designed to apply power to the transmitter element and receiver element respectively during occurrence of the repeating time value and reducing power to the transmitter element and receiver element respectively during the time between the repeating time values.

8. A system as in claim 1 wherein the transmitter module circuit detection algorithm further comprises a subroutine to automatically assign an alarm inactive normal state upon detection of continuity between the medical device and transmitter module connection.

9. A system as in claim 1 wherein the transmitter module further comprises an alarm status input function accessible to a user, and wherein the transmitter module circuit detection algorithm further comprises a subroutine to semi-automatically determine the medical device's actual alarm output configuration based on the alarm status input function.

10. A system as in claim 1 comprising a routine to determine the circuit configuration of the medical device alarm output circuit, the routine comprising the steps of: (1) powering the module ON; (2) connecting the module to the medical device alarm output connector and verifying a connection is made; (3) prompting the user to enable an input to the module wherein the input is either “alarm active” or “alarm inactive”.

11. A system as in claim 1 further comprising an algorithm adapted to transmit the alarm status data package at transmission times that are substantially statistically unique from like transmitter modules, the substantially statistically unique transmission time created by setting the periodicity, or time between two consecutive transmissions, with a number that is generated by the algorithm, where the number is statistically improbable of being repeated for at least 50 repeat cycles.

12. A system as in claim 1 further comprising an algorithm adapted to transmit the alarm status data package at transmission times that are substantially statistically unique from like transmitter modules, the substantially statistically unique transmission time created by setting the time for the first transmission at a statistically unique time using a number generated by the algorithm, and subsequent transmission times at constant periodicity.

13. A system as in claim 1 wherein the medical device is selected from the group: a respiratory ventilator, a cardiac support device, cardiac monitoring device, an incubator, an infusion system, a heart-lung support system, or a kidney support system.

14. A system as in claim 1 wherein the receiver module is paired with multiple transmitter modules to monitor multiple patients receiving care from multiple medical devices.

15. A system as in claim 1 further comprising a docking station adapted to perform one or more of the following functions: store the receiver module, charge the power of the receiver module, perform diagnostic testing of the receiver module, download data stored in the receiver module.

16. A system as in claim 1 comprising a receiving data packet reliability determination algorithm, the algorithm adapted to read an incoming signal on a repeating cycle and adapted to determine if data is reliable or if data is unreliable by comparing (a) a number of signal read cycles with (b) a number of signal read cycles in which an arithmetic sum of parts of the data packet matches an expected sum.

17. A system as in claim 1 wherein the receiver module comprises a user interface including a master visual alert adapted to be seen by a user regardless of user's viewing angle to the receiver module.

18. A wireless system to monitor the alarm event status of a medical device with a plurality of alarm types, the wireless system comprising:
(a) an alarm monitoring module comprising:
(1) an alarm differentiation algorithm adapted to monitor the alarm status of the medical device and further adapted to distinguish between a first alarm type and a second alarm type;
(2) a transmitter element with a wireless transmission range;
(3) a second algorithm adapted to repeatedly create and wirelessly transmit an alarm type data package corresponding to an alarm type occurring with the medical device;
(b) a wireless receiver module programmed to wirelessly communicate with the alarm monitoring module and further comprising:
(1) a receiving element adapted to receive wireless signals;
(2) a first algorithm adapted to determine if a received signal is from the alarm monitoring module;
(3) a second algorithm adapted to process the received signal if a received signal is determined to be from the alarm monitoring module;
(4) a user interface adapted to communicate the alarm type of the medical device to a user based on the processed received signal.

19. A system as in claim 18 wherein the alarm differentiation algorithm consists of a protocol of the following group: alarm duration, alarm repeating frequency, alarm persistence, alarm amplitude, alarm code.

20. A system as in claim 18 further comprising (a) a wireless device connecting the system to a wide-area network consisting of: an internet network, a wireless network, (b) a patient data management system consisting of: a protocol to describe the alarm history of the medical device, a user interface to convey the alarm history to a user.
